(19) United States
(12) Patent Application Publication
(10) Pub. No.: US 2024/0129034 A1
(43) Pub. Date: Apr. 18, 2024

(54) FORWARD RAMAN AMPLIFIER, BIDIRECTIONAL RAMAN AMPLIFICATION SYSTEM, AND FORWARD RAMAN AMPLIFICATION SYSTEM

(71) Applicant: Fujitsu Limited, Kawasaki-shi (JP)

(72) Inventors: Hiroshi NAKAMOTO, Kawasaki (JP); GOJI NAKAGAWA, Sagamihara (JP); Kentaro KAWANISHI, Kawasaki (JP); Hiroki OI, Kawasaki (JP); Tomohiro YAMAUCHI, Kawasaki (JP); Takafumi TERAHARA, Kawasaki (JP); Teppei OHATA, Fukuoka (JP)

(73) Assignee: Fujitsu Limited, Kawasaki-shi (JP)

(21) Appl. No.: 18/220,855

(22) Filed: Jul. 12, 2023

(30) Foreign Application Priority Data
Oct. 14, 2022 (JP) 2022-165898
Jan. 12, 2023 (JP) 2023-003406

(51) Int. Cl. H04B 10/291; H01S 3/067; H01S 3/30

(52) U.S. Cl. CPC H04B 10/2916; H01S 3/06787; H01S 3/302; H04B 2210/003

(57) ABSTRACT

A forward Raman amplifier includes a plurality of pumping light sources with different wavelengths and the forward Raman amplifier, according to a fiber type or a zero-dispersion wavelength of the fiber, changes the number of pumping light sources to be emitted, changes a power ratio between the plurality of pumping light sources with the different wavelengths or changes wavelength characteristics of a gain, according to a fiber type.

### CROSS-REFERENCE TO RELATED APPLICATION

This application is based upon and claims the benefit of priority of the prior Japanese Patent Application Nos. 2023-3406, filed on Jan. 12, 2023, and 2022-165898, filed on Oct. 14, 2022, the entire contents of which are incorporated herein by reference.

### FIELD

The embodiment discussed herein is related to a forward Raman amplifier, a bidirectional Raman amplification system, and a forward Raman amplification system.

### BACKGROUND

A large-capacity signal can be transmitted through optical transmission by wavelength division multiplexing (WDM), and signal light can be optically amplified through Raman amplification and can be transmitted over a long distance. For example, a single mode optical fiber (SMF) or a dispersion shifted fiber (DSF) is used as an optical transmission line.

Japanese Laid-open Patent Publication No. 2005-303070, Japanese Laid-open Patent Publication No. 2004-258622, and “Co-Propagating Dual-Order Distributed Raman Amplifier Utilizing Incoherent Pump” Mori moto et. al., IEEE PHOTONICS TECHNOLOGY LETTERS, VOL. 29, NO. 7, Apr. 1, 2017 are disclosed as related art.

### SUMMARY

According to an aspect of the embodiments, a forward Raman amplifier includes a plurality of pumping light sources with different wavelengths, and the forward Raman amplifier, according to a fiber type or a zero-dispersion wavelength of the fiber, changes the number of pumping light sources to be emitted, changes a power ratio between the plurality of pumping light sources with the different wavelengths, or changes wavelength characteristics of a gain, according to a fiber type.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is an explanatory diagram illustrating an outline of a forward Raman amplifier according to an embodiment (part 1);

FIG. 1B is an explanatory diagram illustrating the outline of the forward Raman amplifier according to the embodiment (part 2);

FIG. 1C is an explanatory diagram illustrating the outline of the forward Raman amplifier according to the embodiment (part 3);

FIG. 1D is an explanatory diagram illustrating the outline of the forward Raman amplifier according to the embodiment (part 4);

FIG. 1E is an explanatory diagram illustrating an outline of a bidirectional Raman amplification system according to the embodiment;

FIG. 1F is a flowchart illustrating a pumping light control example according to the embodiment;

FIG. 2 is a table illustrating a power profile through forward pumping Raman amplification;

FIG. 3 is a table illustrating a wavelength relationship between signal light and pumping light;

FIG. 4 is a diagram illustrating Raman amplification by incoherent pumping light;

FIG. 5 is a table illustrating wavelength dispersion characteristics for each fiber type;

FIG. 6 is a table for explaining a problem occurring in the forward pumping Raman amplification for a DSF;

FIG. 7A is a table illustrating deterioration in a Q factor and a Raman gain due to XPM (SMF);

FIG. 7B is a table illustrating the deterioration in the Q factor and the Raman gain due to the XPM (DSF);

FIG. 7C is a table illustrating the deterioration in the Q factor and the Raman gain due to the XPM (Embodiment);

FIG. 8 is a diagram illustrating a configuration example 1 of an optical transmission system according to the embodiment;

FIG. 9 is a table illustrating an example of an information table;

FIG. 10 is a table illustrating an example of a pumping light power ratio table;

FIG. 11 is a diagram illustrating a hardware configuration example of a control unit of an optical transmission device;

FIG. 12 is a flowchart illustrating a pumping light control example according to the configuration example 1;

FIG. 13 is a diagram illustrating a configuration example 2 of the optical transmission system according to the embodiment;

FIG. 14 is a flowchart illustrating a pumping light control example according to the configuration example 2;

FIG. 15 is a diagram illustrating a configuration example 3 of the optical transmission system according to the embodiment;

FIG. 16 is a diagram for explaining extraction of signal light and pumping light of XPM deterioration;

FIG. 17 is a table illustrating an example of an information table according to the configuration example 3;

FIG. 18A is a table illustrating a transmission-side pumping light power ratio table according to the configuration example 3 (part 1);

FIG. 18B is a table illustrating the transmission-side pumping light power ratio table according to the configuration example 3 (part 2);

FIG. 18C is a table illustrating the transmission-side pumping light power ratio table according to the configuration example 3 (part 3);

FIG. 19 is a table illustrating a reception-side pumping light power ratio table according to the configuration example 3;

FIG. 20A is a flowchart illustrating a pumping light control example according to the configuration example 3 (part 1);

FIG. 20B is a flowchart illustrating the pumping light control example according to the configuration example 3 (part 2);

FIG. 21 is a table illustrating wavelength dispersion characteristics of a true wave reduced slope (TWRS) and an enhanced large effective area fiber (ELEAF);

FIG. 22A is a table for explaining a problem occurring in forward pumping Raman amplification for the TWRS (part 1);

FIG. 22B is a table for explaining the problem occurring in the forward pumping Raman amplification for the TWRS (part 2);

FIG. 22C is a table for explaining the problem occurring in the forward pumping Raman amplification for the TWRS (part 3);

FIG. 23 is a table illustrating deterioration in the Q factor caused by the XPM;

FIG. 24A is a table for explaining a problem occurring in forward pumping Raman amplification for the ELEAF (part 1);

FIG. 24B is a table for explaining the problem occurring in the forward pumping Raman amplification for the ELEAF (part 2);

FIG. 24C is a table for explaining the problem occurring in the forward pumping Raman amplification for the ELEAF (part 3);

FIG. 25 is a table illustrating the deterioration in the Q factor caused by the XPM;

FIG. 26 is an explanatory diagram illustrating a pumping control example for the TWRS;

FIG. 27 is a table illustrating Raman gains before and after XPM countermeasures;

FIG. 28 is a table illustrating Q factors before and after the XPM countermeasures;

FIG. 29 is an explanatory diagram illustrating a pumping control example for the ELEAF;

FIG. 30 is a table illustrating the Raman gains before and after the XPM countermeasures;

FIG. 31 is a table illustrating the Q factors before and after the XPM countermeasures;

FIG. 32 is a flowchart illustrating a pumping light control example compatible with various fibers according to the embodiment;

FIG. 33 is a waveform diagram illustrating spectra before and after XPM occurrence;

FIG. 34 is a diagram illustrating a configuration example of an optical transmission system that performs XPM countermeasure with an OSNR monitor;

FIG. 35 is a flowchart of a processing example of detecting a wavelength of XPM deterioration with the OSNR monitor;

FIG. 36 is a flowchart of a pumping control example for a wavelength of the XPM deterioration; and

FIG. 37 is a table of an example for explaining determination of a power reduction amount of primary pumping light that causes the XPM.

### DESCRIPTION OF EMBODIMENTS

As the related art, for example, there is a technology that stabilizes signal light in a bidirectionally pumped transmission line and performs Raman amplification, by optimizing forward pumping light and backward pumping light power based on a measurement result of an optical signal to noise ratio (OSNR) of signal light that has been Raman amplified at the time when a system is activated. Furthermore, there is a technology that performs forward pumping at a wavelength λp0, performs backward pumping with N channels at wavelengths λp1 to λpN, and controls forward pumping light so that an output power level of each signal channel becomes a predetermined value, so as to improve transient response characteristics without depending on addition/reduction of the signal channels. Furthermore, a pumping Raman amplification technology using incoherent pumping light is disclosed.

The inventors and the like have found, through measurements and simulations that, although forward pumping Raman achieves an effect for improving signal quality in an SMF, the signal quality is deteriorated, for example, in a case where L band transmission is performed with a DSF. For example, in the DSF, a WDM signal and forward pumping light are arranged with a zero-dispersion wavelength (around 1550 nm) of a fiber therebetween. In this case, a part of signal light having a delay equal to the forward pumping light deteriorates the signal quality by being affected by cross phase modulation (XPM) (details will be described later).

In one aspect, an object of the embodiment is to suppress XPM deterioration of signal light according to a fiber type of an optical transmission line.

### Pumping Control Example for DSF

Hereinafter, embodiments of a forward Raman amplifier, a bidirectional Raman amplification system, and a forward Raman amplification system according to the present disclosure will be described in detail with reference to the drawings. The embodiments cope with a case where fiber types used for an optical transmission line are different and cause any fiber type to maintain signal quality of signal light. For example, there is a case where a DSF and a dispersion shifted fiber are used as the optical transmission line, in addition to an SMF. In the embodiment, an effect of deterioration in an XPM on the signal light that is caused in a case of the DSF and the dispersion shifted fiber, the deterioration in the signal quality is suppressed. Therefore, in the embodiment, for example, in a case of the DSF, control for optimizing output of forward pumping light or output of bidirectional pumping light including the forward pumping light and backward pumping light is performed, based on optical transmission characteristics (profile) unique to the DSF.

(Outline of Pumping Control According to Embodiment)

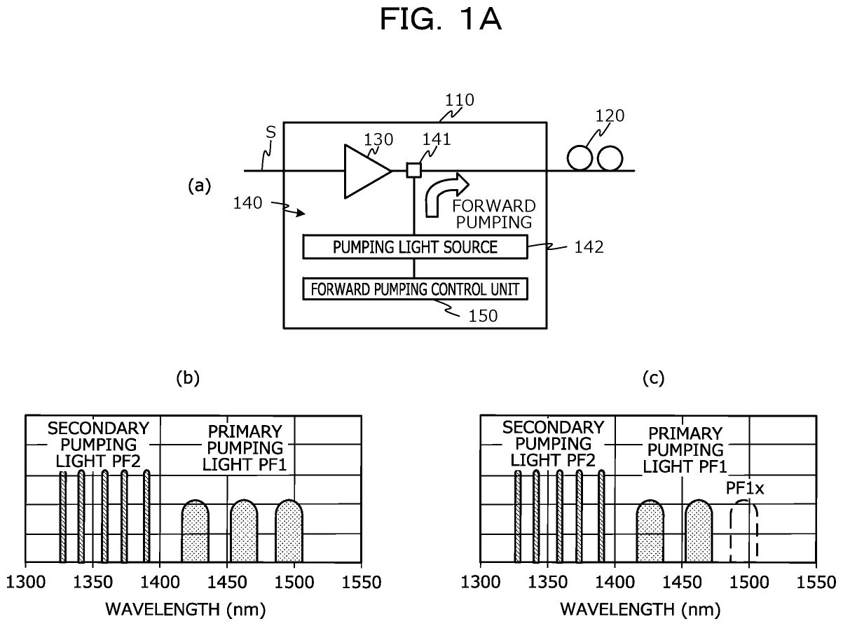

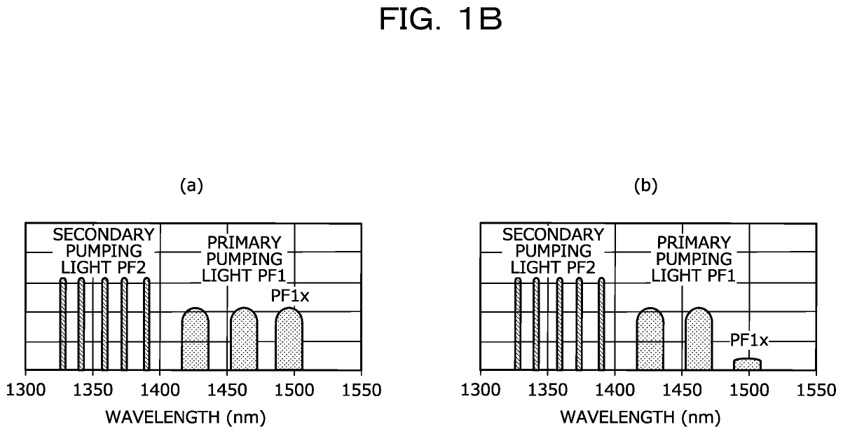

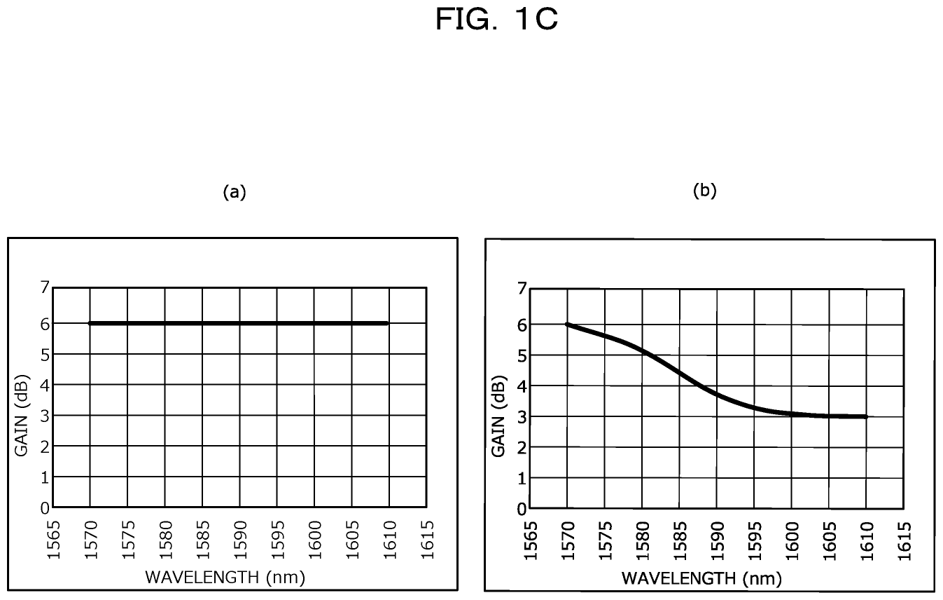

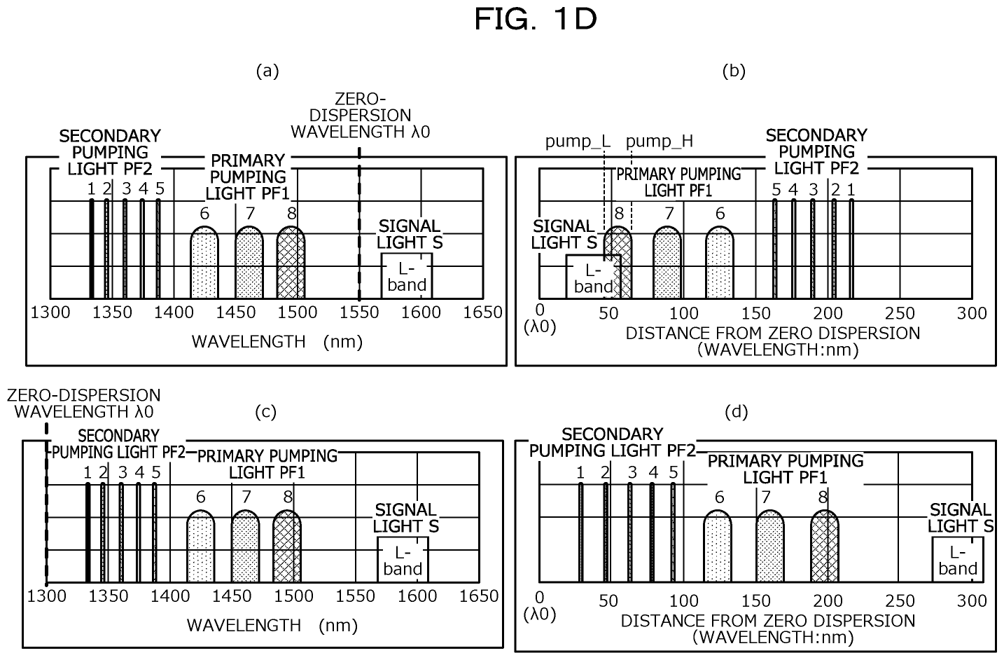

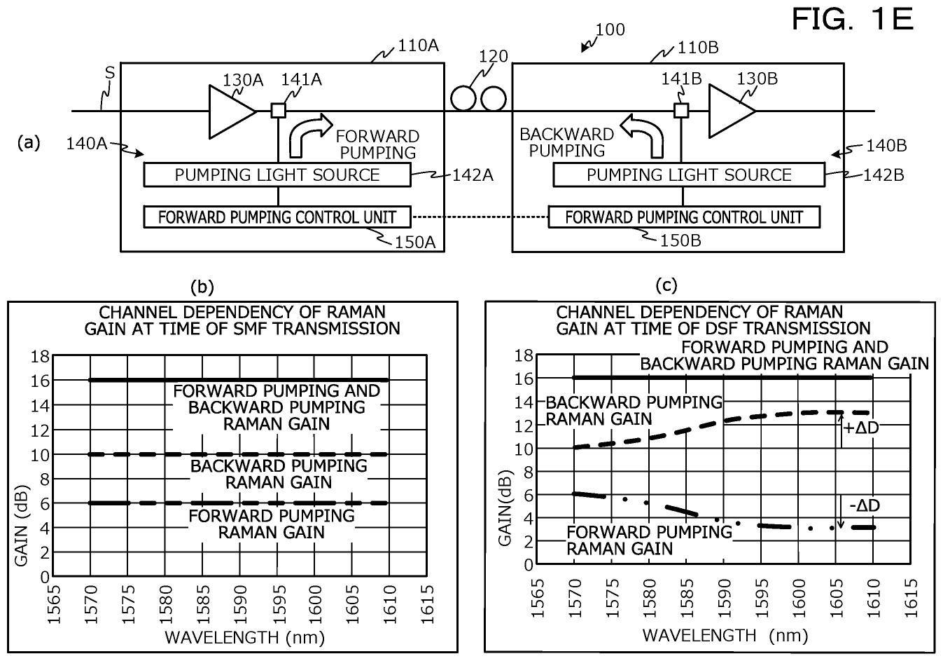

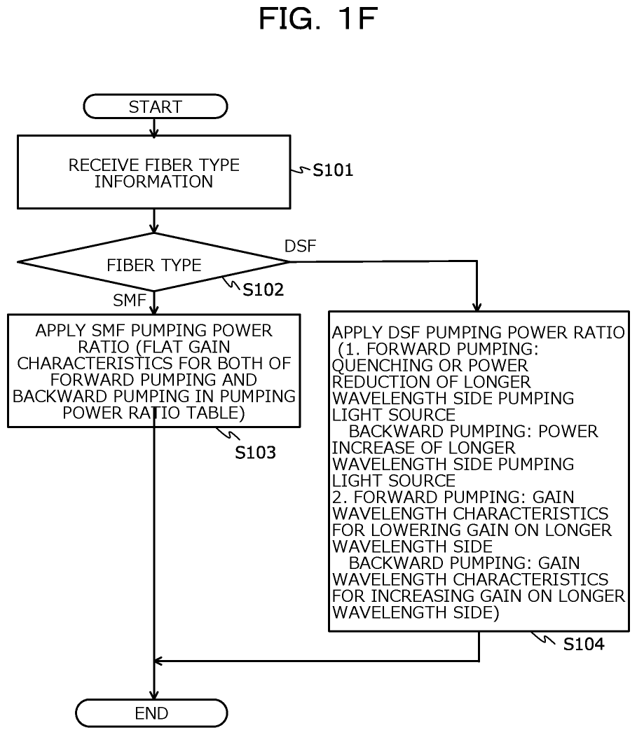

FIGS. 1A to ID are explanatory diagrams illustrating an outline of a forward Raman amplifier according to an embodiment.

### Control Example 1

First, a control example 1 of forward pumping will be described with reference to FIG. 1A. FIG. 1A(a) illustrates a configuration of forward Raman amplification by an optical transmission device 110. The optical transmission device 110 transmits signal light S through an optical transmission line 120.

In FIG. 1A(a), an internal configuration is simplified. However, the optical transmission device 110 includes an optical amplifier 130 such as an erbium doped fiber amplifier (EDFA), a forward pumping unit 140, and a forward pumping control unit 150. The forward pumping unit 140 outputs pumping light having a plurality of wavelengths of a pumping light source 142 to the optical transmission line 120 via a multiplexer 141 and performs forward pumping on the WDM signal light S. The forward pumping control unit 150 controls the output of the forward pumped pumping light.

Next, the control example 1 of the forward pumping will be described with reference to FIGS. 1A(b) and 1A(c). In the control example 1, a forward Raman amplifier having a plurality of pumping light sources with different wavelengths suppresses XPM deterioration by changing the number of pumping light sources to be emitted, according to a fiber type. The horizontal axis in FIGS. 1A(b) and 1A(c) indicates a wavelength, and the vertical axis indicates pumping power.

FIG. 1A(b) illustrates a pumping control state of the forward pumping light in a case where the optical transmission line 120 is an SMF. In a case where the fiber type of the optical transmission line 120 is the SMF, the forward pumping control unit 150 controls forward pumping caused by forward pumping light PF including primary pumping light PF1 and secondary pumping light PF2 on a shorter wavelength side of the primary pumping light PF1, for the forward pumping unit 140.

FIG. 1A(c) illustrates a pumping control state of the forward pumping light in a case where the optical transmission line 120 is a DSF. In a case where the fiber type of the optical transmission line 120 is the DSF, the forward pumping control unit 150 changes the number of pumping light sources to be emitted, among the plurality of beams of primary pumping light PF1, for the pumping light source 142 of the forward pumping unit 140.

For example, the forward pumping control unit 150 turns off (quenches) power of primary pumping light PF1x with some wavelengths among the plurality of pumping wavelengths of the primary pumping light PF1 and performs forward pumping with the primary pumping light PF1 with a wavelength other than that of the primary pumping light PF1x. In the example in FIG. 1A(c), the forward pumping control unit 150 quenches the primary pumping light PF1x positioned on the longest wavelength side, among the plurality of pumping wavelengths of the primary pumping light PF1.

As illustrated in FIG. 1A(b), in a case where the fiber type used for the optical transmission line 120 is the SMF, the forward pumping control unit 150 performs forward pumping with the pumping light sources 142 having all the wavelengths of the primary pumping light PF. On the other hand, as illustrated in FIG. 1A(c), in a case where the fiber type used for the optical transmission line 120 is the DSF, the forward pumping control unit 150 performs forward pumping with a wavelength other than that of the primary pumping light PF1x with some wavelengths among the wavelengths of the primary pumping light PF.

Here, in a case where the DSF is used for the optical transmission line 120, the primary pumping light PF1x with some wavelengths has a wavelength that causes the XPM deterioration of the signal light S. For example, in a case of acquiring information indicating that the fiber type is the DSF, the forward pumping control unit 150 suppresses the XPM deterioration of the signal light S by forward pumping the primary pumping light PF with the wavelength other than that of the primary pumping light PF1x of some wavelengths and prevents signal deterioration of the signal light S. Details of the XPM deterioration caused in a case where the DSF is used for the optical transmission line 120 will be described later.

Furthermore, in relation to the control example 1, the optical transmission device 110 may mount a pumping light source with a wavelength that does not fall within a wavelength band obtained by folding a wavelength band of signal light with respect to a zero-dispersion wavelength of a fiber on a wavelength axis where forward pumping is performed. For example, the forward pumping unit 140 may mount a pumping light source other than the pumping light source corresponding to the primary pumping light PF1x with the wavelength that causes the XPM deterioration of the signal light S, from among a plurality of primary pumping light sources.

### Control Example 2

Next, a control example 2 of the forward pumping will be described with reference to FIG. 1B. In the control example 2 in FIG. 1B, the optical transmission device 110 has a configuration as in FIG. 1A(a) and controls the forward Raman amplification. In the control example 2, a forward Raman amplifier having a plurality of pumping light sources with different wavelengths suppresses the XPM deterioration by changing a power ratio between the plurality of pumping light sources with the different wavelengths, according to the fiber type. The horizontal axis in FIG. 1B indicates a wavelength, and the vertical axis indicates pumping power.

FIG. 1B(a) illustrates a pumping control state of forward pumping light in a case where the optical transmission line 120 is the SMF. In a case where the fiber type of the optical transmission line 120 is the SMF, as in FIG. 1A(b), the forward pumping control unit 150 controls forward pumping caused by the forward pumping light PF including the primary pumping light PF1 and the secondary pumping light PF2 on a shorter wavelength side of the primary pumping light PF1, for the forward pumping unit 140.

FIG. 1B(b) illustrates a pumping control state of forward pumping light in a case where the optical transmission line 120 is the DSF. In a case where the fiber type of the optical transmission line 120 is the DSF, the forward pumping control unit 150 changes a power ratio between the plurality of primary pumping light sources PF1 having different wavelengths, for the pumping light source 142 of the forward pumping unit 140.

For example, the forward pumping control unit 150 performs forward pumping for reducing the power of the primary pumping light PF1x with some wavelengths among the plurality of pumping wavelengths of the primary pumping light PF1, as compared with other wavelengths. In the example in FIG. 1B(b), the forward pumping control unit 150 lowers the power of the primary pumping light PF1x positioned on the longest wavelength side among the plurality of pumping wavelengths of the primary pumping light PF1 to be lower than power of the primary pumping light PF with the other wavelengths.

Here, as illustrated in FIG. 1B(a), in a case where the fiber type used for the optical transmission line 120 is the SMF, for example, the forward pumping control unit 150 performs forward pumping at a fixed power ratio of all the wavelengths of the primary pumping light PF, on the pumping light source 142. On the other hand, as illustrated in FIG. 1B(b), in a case where the fiber type used for the optical transmission line 120 is the DSF, the forward pumping control unit 150 performs forward pumping for reducing the power of the primary pumping light PF1x with some wavelengths, of the primary pumping light PF.

Here, in a case where the DSF is used for the optical transmission line 120, the primary pumping light PF1x with some wavelengths has a wavelength that causes the XPM deterioration of the signal light S. Therefore, in a case where the fiber type is set as the DSF, the forward pumping control unit 150 suppresses the XPM deterioration of the signal light S by performing the forward pumping for reducing the power of the primary pumping light PF1x with some wavelengths on the primary pumping light PF and prevents the signal deterioration of the signal light S.

### Control Example 3

Next, a control example 3 of the forward pumping will be described with reference to FIG. 1C. In the control example 3 in FIG. 1C, the optical transmission device 110 has a configuration as in FIG. 1A(a) and controls the forward Raman amplification. In the control example 3, a forward Raman amplifier having a plurality of pumping light sources with different wavelengths suppresses the XPM deterioration by changing wavelength characteristics of a gain, for example, an inclination with respect to a wavelength of a gain, according to the fiber type. The horizontal axis of FIG. 1C indicates a wavelength of the signal light S in an L band, and the vertical axis indicates a Raman gain.

FIG. 1C(a) illustrates a pumping control state of forward pumping light in a case where the optical transmission line 120 is the SMF. In a case where the fiber type of the optical transmission line 120 is the SMF, the forward pumping control unit 150 controls forward pumping so as to fix a Raman gain for an entire wavelength band of the signal light S, for the forward pumping unit 140. The forward pumping unit 140 performs forward pumping including the primary pumping light and the secondary pumping light, as in FIG. 1A(a).

FIG. 1C(b) illustrates a pumping control state of forward pumping light in a case where the optical transmission line 120 is the DSF. In a case where the fiber type of the optical transmission line 120 is the DSF, the forward pumping control unit 150 changes the inclination with respect to the wavelength of the gain, for the pumping light source 142 of the forward pumping unit 140.

In the example in FIG. 1C(b), a gain on the shorter wavelength side is the highest, and the forward pumping control unit 150 changes the inclination with respect to the wavelength of the gain by gradually reducing the gain toward the longer wavelength side. For example, the inclination of the gain is obtained by setting power of primary pumping light on the shorter wavelength side to be the highest, among the plurality of pumping wavelengths of the primary pumping light PF1 described with reference to FIG. 1A(c) and gradually reducing the power of the primary pumping light toward the longer wavelength side.

Here, in a case where the fiber type used for the optical transmission line 120 is the SMF, for example, the forward pumping control unit 150 obtains the gain characteristics illustrated in FIG. 1C(a) by performing forward pumping at the fixed power ratio of all the wavelengths of the primary pumping light PF, on the pumping light source 142. On the other hand, in a case where the fiber type used for the optical transmission line 120 is the DSF, the forward pumping control unit 150 sets the power of the primary pumping light on the shorter wavelength side among the pumping wavelengths of the primary pumping light PF1 to be the highest and performs forward pumping for gradually reducing the power of the primary pumping light PF1 toward the longer wavelength side. As a result, the gain characteristics illustrated in FIG. 1C(b) are obtained.

Here, in a case where the DSF is used for the optical transmission line 120, the long wavelength PF1x of the primary pumping light PF1 is a wavelength that causes the XPM deterioration of the signal light S. Therefore, in a case where the fiber type is set as the DSF, the forward pumping control unit 150 suppresses the XPM deterioration of the signal light S by obtaining the gain characteristics illustrated in FIG. 1C(b) and prevents the signal deterioration of the signal light S.

In the control examples 1 to 3 described above, pumping control according to the zero-dispersion wavelength of the fiber may be performed. For example, in the control example 1, the number of pumping light sources to be emitted may be changed according to the zero-dispersion wavelength of the fiber. In a case where the fiber type is the DSF, the zero-dispersion wavelength is around 1550 nm. Then, in a case where the XPM deterioration occurs in a part of the signal light S according to the zero-dispersion wavelength of the fiber, for example, the number of pumping light sources to be emitted is changed by quenching the wavelength PF1x of a part of the primary pumping light PF1 that copes with the deterioration, and the XPM deterioration of the signal light S is suppressed.

Similarly, in the control example 2, the power ratio between the plurality of pumping light sources with different wavelengths may be changed according to the zero-dispersion wavelength of the fiber, and in the control example 3, the inclination with respect to the wavelength of the gain may be changed according to the zero-dispersion wavelength of the fiber.

### Control Example 4

Next, a control example 4 of the forward pumping will be described with reference to FIG. 1D. In the control example 4 in FIG. 1D, the optical transmission device 110 controls the forward Raman amplification with a configuration as in FIG. 1A(a). In the control example 4, regarding an amount of a change in the forward pumping power described in the control examples 1 to 3, the optical transmission device 110 suppresses the XPM deterioration by determining whether or not signal light exists within the wavelength band obtained by folding the pumping light wavelength with respect to the zero-dispersion wavelength on the wavelength axis. The horizontal axis of FIG. 1D indicates a wavelength, and the vertical axis indicates power.

FIG. 1D(a) is a diagram illustrating wavelengths of signal light and pumping light with the XPM deterioration. In FIG. 1D(a), arrangement of a signal band (L band) of the signal light S and pumping light in a case where the optical transmission line 120 is the DSF is illustrated, and the horizontal axis indicates a wavelength, and the vertical axis indicates optical power. For convenience, numbers λ1 to λ5 are given to respective wavelengths (λ) from the shorter wavelength side of the secondary pumping light to the longer wavelength side, and numbers λ6 to λ8 are given to respective wavelengths (λ) from the shorter wavelength side of the primary pumping light to the longer wavelength side. In FIG. 1D(a), a zero-dispersion wavelength λ0 of the DSF (1550 nm) is written. Note that the zero-dispersion wavelength of the SMF is around 130 nm.

In FIG. 1D(b), in a case where the optical transmission line 120 is the DSF, the signal band (L band) of the signal light S and the pumping light illustrated in FIG. 1D(a) are rearranged at distances from the zero-dispersion wavelength on the wavelength axis. The horizontal axis indicates a distance (wavelength) from the zero-dispersion wavelength, and the left end of the horizontal axis is set to zero.

As illustrated in FIG. 1D(b), it is illustrated that, in a case where a signal with each wavelength is folded at the zero-dispersion wavelength λ0, a wavelength of the L band on the longer wavelength side of the signal light S overlaps primary pumping light with λ8 on the longer wavelength side among the primary pumping light PF1.

Note that, FIG. 1D(c) illustrates the pumping light wavelength, the signal band, and a position of the zero-dispersion wavelength on the wavelength axis in a case where the optical transmission line 120 is the SMF. Furthermore, in FIG. 1D(c), the optical transmission line 120 is the SMF, and the signal band (L band) of the signal light S and the pumping light are rearranged at distances from the zero-dispersion wavelength on the wavelength axis. In a case of the SMF, no pumping light PF overlaps the signal light S.

In this way, in a case where the optical transmission line 120 is the DSF, the amount of the change in the forward pumping power described in the control examples 1 to 3 can be determined according to whether or not the signal light exists within the wavelength band obtained by folding the pumping light wavelength with respect to the zero-dispersion wavelength on the wavelength axis illustrated in FIG. 1D(b). For example, in a case where the signal light S exists within the wavelength band obtained by folding the wavelength of the pumping light PF1 with respect to the zero-dispersion wavelength λ0 on the wavelength axis, the forward pumping control unit 150 suppresses the XPM deterioration of the signal light S by changing forward pumping power of the primary pumping light λ8 overlapping the signal light S.

For example, in an application example to the control example 1, in a case where the signal light S exists within the wavelength band obtained by folding the pumping light wavelength with respect to the zero-dispersion wavelength λ0 on the wavelength axis, as illustrated in FIG. 1A(c), the power of the pumping light source with the wavelength PF1x is turned off. Furthermore, in an application example to the control example 2, in a case where the signal light S exists within the wavelength band obtained by folding the pumping light wavelength with respect to the zero-dispersion wavelength λ0 on the wavelength axis, as illustrated in FIG. 1B(b), a pumping light power ratio of the existing wavelength PF1x is lowered to be less than a pumping light power ratio of a wavelength that does not exist. Furthermore, in an application example to the control example 3, in a case where the signal light S exists within the wavelength band obtained by folding the pumping light wavelength with respect to the zero-dispersion wavelength λ0 on the wavelength axis, as illustrated in FIG. 1C(b), a gain is inclined so as to reduce a gain of the signal wavelength.

In a case where the pumping light is folded at the zero-dispersion wavelength AO in the DSF in the control example 4, a plurality of patterns of the pumping light and the band of the signal light S overlapping with each other is considered, depending on a band of the signal light S and a band of each of the wavelengths λ1 to λ8 of the plurality of beams of pumping light PF. The plurality of patterns of overlap between the wavelengths of the signal light S and the pumping light PF will be described later.

### Control Example 5

FIG. 1E is an explanatory diagram illustrating an outline of a bidirectional Raman amplification system according to the embodiment. A control example 5 of the bidirectional Raman amplification system by forward pumping and backward pumping will be described with reference to FIG. 1E.

In the control example 5, backward Raman pumping that causes an inclination of an opposite gain with respect to a wavelength is performed so as to compensate the inclination of the gain with respect to the wavelength caused through forward Raman pumping described in each of the control examples 1 to 4 described above.

FIG. 1E(a) illustrates a configuration example of an optical transmission system according to the bidirectional Raman amplification system of the embodiment. In the example in FIG. 1E, an example of a pair of optical transmission devices 110A and 110B of which a section of the optical transmission line 120 to be a pumping light control target is one span is illustrated. The upstream first optical transmission device 110A is coupled to one end of a DSF 120, and the downstream second optical transmission device 110B is coupled to another end of the DSF 120.

In the first optical transmission device 110A, a forward pumping unit 140A is arranged at a subsequent stage of an optical amplifier 130A, as in the configuration of FIG. 1A(a) described above. The forward pumping unit 140A outputs pumping light of a pumping light source 142A to the DSF 120 via a multiplexer 141A and performs forward pumping on WDM signal light S. A forward pumping control unit 150A controls the output of the forward pumped pumping light.

Furthermore, in the second optical transmission device 110B, a multiplexer 141B of a backward pumping unit 140B is arranged at a preceding stage of an optical amplifier 130B, and pumping light of a pumping light source 142B is supplied to the DSF 120 via the multiplexer 141B and performs backward pumping on the signal light. A backward pumping control unit 150B controls output of backward pumped pumping light.

The forward pumping control unit 150A of the first optical transmission device 110A and the backward pumping control unit 150B of the second optical transmission device 110B are electrically coupled to each other via a network. For example, the forward pumping control unit 150A notifies the backward pumping control unit 150B of control information such as a wavelength of the pumping light output by the pumping light source 142A. The network may include an optical transmission line.

Furthermore, although not illustrated in FIG. 1E, an integrated control unit that integrally controls the forward pumping control unit 150A and the backward pumping control unit 150B may be additionally arranged (details will be described later). In this case, the integrated control unit integrally controls control information such as a wavelength of pumping light of the pumping light source 142A of the forward pumping unit 140A and the pumping light source 142B of the backward pumping unit 140B.

Here, a control example related to suppression of XPM deterioration will be described with reference to FIGS. 1E(b) and 1E(c). FIG. 1E(b) is a diagram illustrating an outline of pumping light control of the forward pumping unit 140A. In FIG. 1E(b), the horizontal axis indicates a wavelength, and the vertical axis indicates optical power. In the first optical transmission device 110A, a wavelength of the forward pumping light PF is arranged on the shorter wave side of the zero-dispersion wavelength λ0 around the zero-dispersion wavelength (for example, around 1550 nm) λ0 of the DSF 120, and the wavelength of the signal light S of the L band is arranged on the longer wavelength side of the zero-dispersion wavelength. The forward pumping unit 140A includes the primary pumping light PF1 on a wavelength side close to the zero-dispersion wavelength and the secondary pumping light PF2 on a wavelength side away from the zero-dispersion wavelength AO, as the forward pumping light PF.

In a case of wavelength arrangement illustrated in FIG. 1E(b), a delay of the forward pumping light PF, for example, the primary pumping light PF1 and a delay of the signal light S are equal to each other. In a case of pumping by partial forward pumping light PF on the longer wavelength side (1500 nm) close to the zero-dispersion wavelength λ0, among the forward pumping light PF, the longer wavelength side Sx of the signal light S is affected by the XPM, and signal quality is deteriorated.

Since light having an equal wavelength interval from the zero-dispersion wavelength λ0 has the same delay amount, a wavelength interval from the primary pumping light PF1x and the zero-dispersion wavelength λ0 of a longer wavelength side Sx of the signal light S are equal to each other, and the longer wavelength side Sx is affected by the XPM. Optical transmission characteristics (profile) unique to the DSF 120, for example, a relationship between the delays of the primary pumping light PF1 and the signal light S based on zero-dispersion wavelength characteristics will be described later in detail.

The forward pumping control unit 150A of the first optical transmission device 110A controls forward pumping by the pumping light source 142A. The forward pumping control unit 150A controls optical power of the primary pumping light PF1x with some wavelengths on the longer wavelength side close to the zero-dispersion wavelength, among the primary pumping light PF1. For example, in the example in FIG. 1E(b), as described in the control example 1, the optical power of the primary pumping light PF1x is turned off (quenched). The forward pumping control unit 150A suppresses the XPM deterioration of the signal light S (Sx), by controlling the forward pumping on the DSF 120.

FIG. 1E(c) is a diagram illustrating an outline of pumping light control of the backward pumping unit 140B. In FIG. 1E(b), the horizontal axis indicates a wavelength, and the vertical axis indicates optical power. The second optical transmission device 110B outputs, for example, backward pumping light PB having a wavelength band similar to that of the forward pumping primary pumping light PF.

A Raman gain becomes insufficient by quenching the forward pumping light PF1x with some wavelengths among the forward pumping light PF by the first optical transmission device 110A. Therefore, in the embodiment, the backward pumping control unit 150B of the second optical transmission device 110B compensates a Raman gain in one span by increasing a gain of backward pumping light PBx corresponding to the wavelength of the quenched forward pumping light PF1x, of the backward pumping light PB.

As a result, for example, even in a case where the DSF is used for the optical transmission line 120, the XPM deterioration of the signal light S is suppressed through the control on the forward pumping. Furthermore, the signal light S can be recovered to a predetermined power level through the control on the backward pumping, quality of a signal to be transmitted can be secured.

In FIG. 1E, in correspondence with the control example 1, the forward pumping light PF1x with some wavelengths of the forward pumping light PF is quenched by the first optical transmission device 110A. Then, the backward pumping control unit 150B of the second optical transmission device 110B compensates a Raman gain in one span by increasing the gain of the backward pumping light PBx corresponding to the wavelength of the quenched forward pumping light PF1x, of the backward pumping light PB.

Moreover, a bidirectional pumping Raman amplification system illustrated in FIG. 1E may correspond to a configuration in which the power ratio between the plurality of pumping light sources having different wavelengths is changed according to the fiber type with the forward pumping light PF in correspondence with the control example 2, and increase the gain of the backward pumping light PBx corresponding to the wavelength of the forward pumping light PF1x of which the power ratio is lowered. Furthermore, in correspondence with the control example 2, the inclination of the gain with respect to the wavelength can be changed with the forward pumping light PF according to the fiber type. For example, in correspondence with the configuration in which the gain is inclined so as to be reduced with the wavelength of the primary pumping light PF1x, the gain of the wavelength corresponding to the wavelength of the primary pumping light PF1x, of the backward pumping light PBx, may be inclined to be increased and be compensated.

FIG. 1F is a flowchart illustrating a pumping light control example according to the embodiment. In the embodiment, as described in the control examples 1 to 4, control content of forward pumping is changed according to the fiber type.

In FIG. 1F, each content of control performed by the forward pumping control unit 150A of the first optical transmission device 110A and the backward pumping control unit 150B of the second optical transmission device 110B in cooperation in the bidirectional pumping control system described in the control example 5 is illustrated.

First, each of the forward pumping control unit 150A and the backward pumping control unit 150B receives fiber type information (step S101). The fiber type information may be manually input by a person in charge maintenance or the like or may be input from a management server or the like via a network.

Next, each of the forward pumping control unit 150A and the backward pumping control unit 150B determines the input fiber type (step S102). Here, it is assumed that the SMF or the DSF described above be input as the fiber type of the optical transmission line 120.

In a case where the input fiber type is the SMF (step S102: SMF), the forward pumping control unit 150A performs forward pumping to which a pumping power ratio for the SMF is applied (step S103). Similarly, the backward pumping control unit 150B performs forward pumping to which the pumping power ratio for the SMF is applied. For example, in control of the forward pumping of the forward pumping control unit 150A and the backward pumping of the backward pumping control unit 150B, the pumping power ratio for the SMF that has been formed as a table in advance is used. The pumping power ratio table for the SMF has gain characteristics flat with respect to the wavelength, for both of the forward pumping and the backward pumping (refer to FIG. 1E(b)).

On the other hand, in a case where the input fiber type is the DSF (step S102: DSF), each of the forward pumping control unit 150A and the backward pumping control unit 150B performs forward pumping to which a pumping power ratio for the DSF is applied (step S104). For example, in control of the forward pumping of the forward pumping control unit 150A and backward pumping of the backward pumping control unit 150B, pumping is controlled with reference to the pumping power ratio for the DSF that has been formed as a table in advance.

For example, 1. in the pumping power ratio table for the DSF, quenching of a longer wavelength side pumping light source for the forward pumping (corresponding to control example 1), power reduction (corresponding to control example 2) is set, and the forward pumping control unit 150A refers to the pumping power ratio table and controls the forward pumping. Correspondingly, about the backward pumping, a power increase of the pumping light source on the longer wavelength side is set to the pumping power ratio table for the DSF, and the backward pumping control unit 150B controls the backward pumping with reference to the pumping power ratio table.

In addition, 2. in the pumping power ratio table for the DSF, gain wavelength characteristics in which a gain is lowered on the longer wavelength side is set for the forward pumping, and the forward pumping control unit 150A controls the forward pumping with reference to the pumping power ratio table. Correspondingly, about the backward pumping, gain wavelength characteristics in which a gain increases on the longer wavelength side are set to the pumping power ratio table for the DSF, and the backward pumping control unit 150B controls the backward pumping with reference to the pumping power ratio table (control example 5 (refer to FIG. 1E(c))).

The forward pumping control unit 150A and the backward pumping control unit 150B end bidirectional pumping control compatible with the fiber type through the control in step S103 or S104. Note that the control in FIG. 1F means bidirectional pumping power setting change based on the fiber type of the optical transmission line 120, and the forward pumping control unit 150A and the backward pumping control unit 150B continuously perform pumping control based on the bidirectional pumping power, of which the setting has been changed, during the operation of the optical transmission line 120.

(About XPM Deterioration Due to Forward Pumping)

Here, typical XPM deterioration will be described. First, Raman amplification will be described. In WDM transmission, due to power increase of signal light transmitted through a one-span fiber (for example, about 100 km), a backward pumping Raman amplification method for increasing input to an erbium doped fiber amplifier (EDFA) is used. Furthermore, a forward pumping Raman amplification method for performing Raman amplification by transmitting pumping light to a transmission side in a direction same as the signal light is also used.

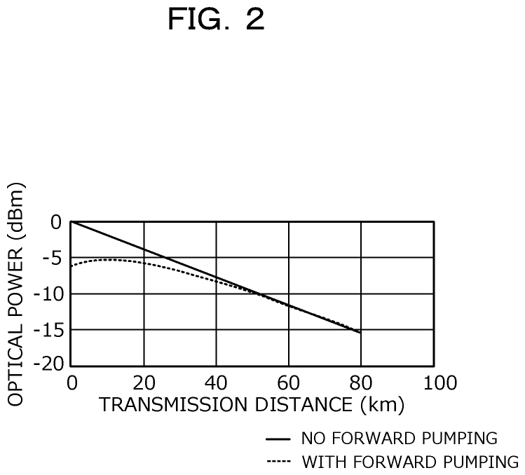

FIG. 2 is a table illustrating a power profile of signal light through forward pumping Raman amplification. The horizontal axis indicates a transmission distance (km), and the vertical axis indicates optical power (dBm). A solid line in FIG. 2 indicates transmission characteristics in a case where the forward pumping Raman amplification is not performed, and a dotted line in FIG. 2 indicates transmission characteristics in a case where the forward pumping Raman amplification has been performed. By performing the forward pumping Raman amplification, there is an advantage such that an optical signal to noise ratio (OSNR) can be secured while suppressing fiber input power and suppressing signal deterioration due to optical non-linearity.

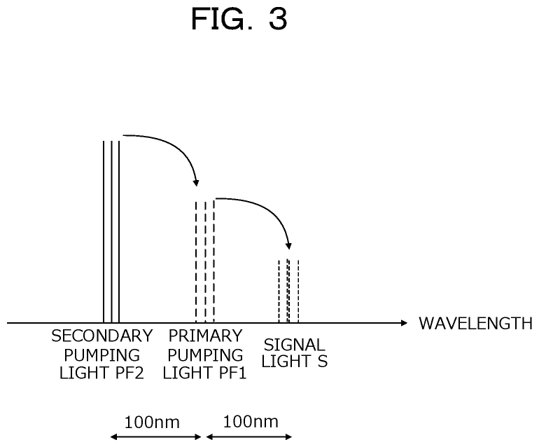

FIG. 3 is a table illustrating a wavelength relationship between signal light and pumping light. The horizontal axis indicates a wavelength, and the vertical axis indicates optical power. In the Raman amplification, it is necessary to arrange pumping light on a short wavelength side of about 100 nm (13 THz) with respect to the wavelength of the signal light S. In a case of a WDM signal, a plurality of beams of pumping light is needed in correspondence with signal light having a plurality of wavelengths. In a case where power of the pumping light is small, secondary pumping light PF2 for performing Raman amplification on the pumping light (primary pumping light PF1) is arranged on the 100 nm shorter wave side of the primary pumping light PF1.

Raman pumping light includes relative intensity noise (RIN). In the forward pumping Raman amplification, the pumping light and the signal light wavelength transmit the fiber of the optical transmission line 120 in the same direction. Therefore, a problem occurs such that signal quality is deteriorated when it is attempted to sufficiently obtain a gain because noise is included in the signal light through the Raman amplification from the pumping light to the signal light.

For this problem, for example, a technology has been disclosed that uses incoherent pumping light (incoherent pump light) having a small RIN and a gently spread spectrum (for example, refer to Morimoto et. al., “Co-Propagating Dual-Order Distributed Raman Amplifier Utilizing Incoherent Pump”, IEEE PHOTONICS TECHNOLOGY LETTERS, VOL. 29, NO. 7, Apr. 1, 2017 described above).

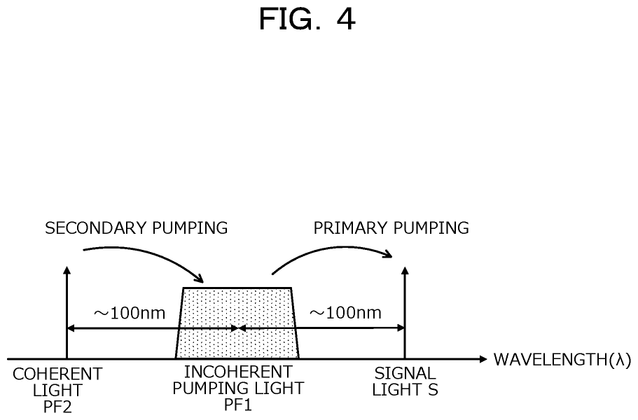

FIG. 4 is a diagram illustrating Raman amplification by the incoherent pumping light. Since incoherent pumping light PF1 illustrated in FIG. 4 has gently spread wavelength characteristics, noises are averaged, and the noise included in the signal light S can be reduced, by receiving the Raman amplification from a portion with a different wavelength. For example, although the Raman amplification is performed from different wavelengths Δλ1, Δλ2, and Δλ3 of the incoherent pumping light PF1 to the signal light S, noises respectively included in these wavelengths Δλ1, Δλ2, and Δλ3 are different. As a result, the noises are averaged through the Raman amplification with the incoherent pumping light, and the noise can be reduced to be equal to or less than 1/10 of that of Raman amplification using line spectrum pumping light. The forward pumping light used in the embodiment may be a combination of incoherent pumping light and coherent light.

In the forward pumping Raman amplification described above, the SMF is effective for improving the signal quality. However, the inventor and the like have found a problem in that the signal quality of the signal light of the L band is deteriorated, through actual measurement and simulations, in a case where the signal light is transmitted with a dispersion shifted fiber such as a DSF.

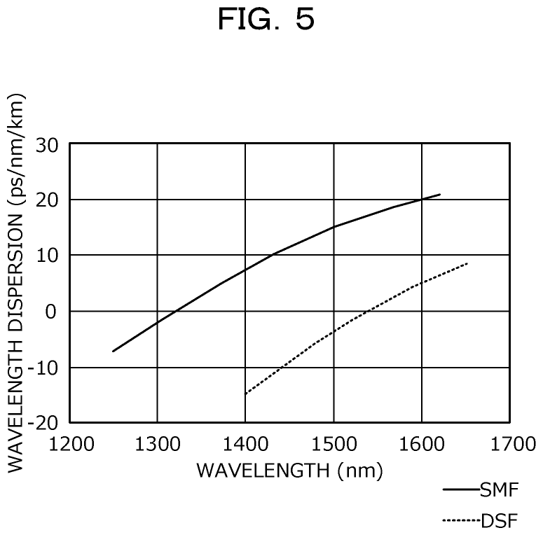

FIG. 5 is a table illustrating wavelength dispersion characteristics for each fiber type. An SMF indicated by a solid line in FIG. 5 has dispersion of zero near the wavelength of 1310 nm, and for example, has dispersion about 17 ps/nm/km in a 1550 nm band with the smallest propagation loss. On the other hand, a DSF has small dispersion in the 1550 nm band. Next, problems in a case where a fiber such as the DSF of which wavelength dispersion characteristics are shifted is used will be described.

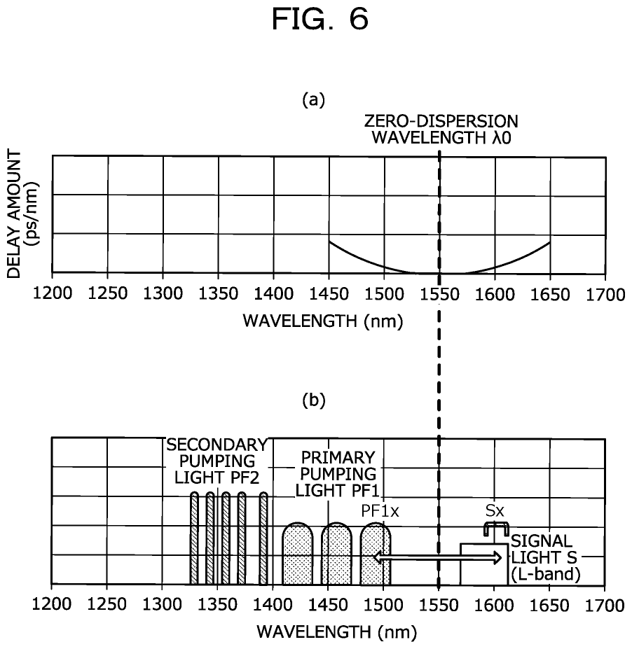

FIG. 6 is a table for explaining a problem occurring in the forward pumping Raman amplification for the DSF. FIG. 6 illustrates a relationship between a zero-dispersion wavelength, a wavelength (L-band) of signal light of the WDM, and a pumping wavelength in a case of the DSF.

In FIG. 6(a), a wavelength pair delay amount of the DSF is illustrated. A speed of a light wave propagating in an optical fiber varies depending on a wavelength (corresponding to wavelength dispersion). When integrating an expression of a wavelength pair wavelength dispersion with respect to a wavelength, a relational expression of the wavelength pair delay amount is formed. As illustrated in FIG. 6(a), a characteristic line of the wavelength pair delay amount is substantially a quadratic function. Regarding this wavelength pair delay amount, light on the shorter wavelength side and light on the longer wavelength side having equal wavelength intervals have the same delay amount, around the zero-dispersion wavelength (1550 nm) Δ0.

FIG. 6(b) is a table illustrating an effect of the XPM with respect to signal light in a case where the DSF is used. As described above, in order to efficiently perform the Raman amplification, the wavelength intervals (arrangement) of the signal light S and the pumping light (primary pumping light PF1) are separated from each other by above 100 nm. Then, as illustrated in FIG. 6(b), the signal light S and the primary pumping light PF1 are arranged with the zero-dispersion wavelength λ0 therebetween. The primary pumping light PF1x having some wavelengths on the longer wavelength side close to the zero-dispersion wavelength λ0, among the primary pumping light PF1, and the longer wavelength side Sx of the signal light S of the L band both have an equal distance (wavelength interval) from the zero-dispersion wavelength λ0.

As described above, since the light having the equal wavelength interval from the zero-dispersion wavelength λ0 has the same delay amount, the longer wavelength side Sx of the signal light S is affected by the XPM with the longer wavelength side PF1x of the primary pumping light PF1. The primary pumping light PF1x on the longer wavelength side has a role of amplifying the longer wavelength side Sx of the signal light S, and the primary pumping light PF1x on the longer wavelength side has a delay equal to a band of the longer wavelength side Sx of the signal light S. For example, a delay of the PF1x with the wavelength 1500 nm is equal to a delay of the signal light Sx with a wavelength 1600 nm. As a result, the signal light Sx on the longer wavelength side of the signal light S is affected by the XPM and causes signal deterioration.

It is known that the XPM occurs between two adjacent signal light beams. However, since a power density of the pumping light PF is several times of that of the signal light S, the large XPM is given to the signal light, and this distorts the waveform of the signal light S and deteriorates the signal quality.

On the other hand, in the embodiment, as described with reference to FIGS. 1A to IF, in a case where the signal light is transmitted through the dispersion shifted fiber such as the DSF, it is avoided to arrange the forward pumping light having the same distance (wavelength interval) as the signal band of the L band around the zero-dispersion wavelength. For example, by reducing the power on the longer wavelength side PF1x of the primary pumping light PF1 by quenching or the like, the signal deterioration by the XPM is avoided.

Regarding the amplification gain by the forward pumping, the pumping light power on the longer wavelength side PF1x is reduced or eliminated so that the gain on the longer wavelength side Sx of the signal light S is lowered. For example, a tilt in which the gain on the longer wavelength side Sx decreases occurs in the signal light S. Although the longer wavelength side Sx receives a gain of pumping light on the shorter wavelength side, the gain is reduced to be less than a required amount. Therefore, an input level of a reception amplifier is lowered, and the signal quality is deteriorated as it is due to shortage of the OSNR. Therefore, in the embodiment, by increasing a gain on the longer wavelength PBx side of the backward pumping, a power level on the longer wavelength side Sx of the signal light S is recovered. In this way, in the embodiment, the signal deterioration caused by the XPM of the forward pumping light is avoided, and the signal quality is secured. At this time, the backward pumping causes a tilt in which the gain on the longer wavelength side Sx of the signal light S increases.

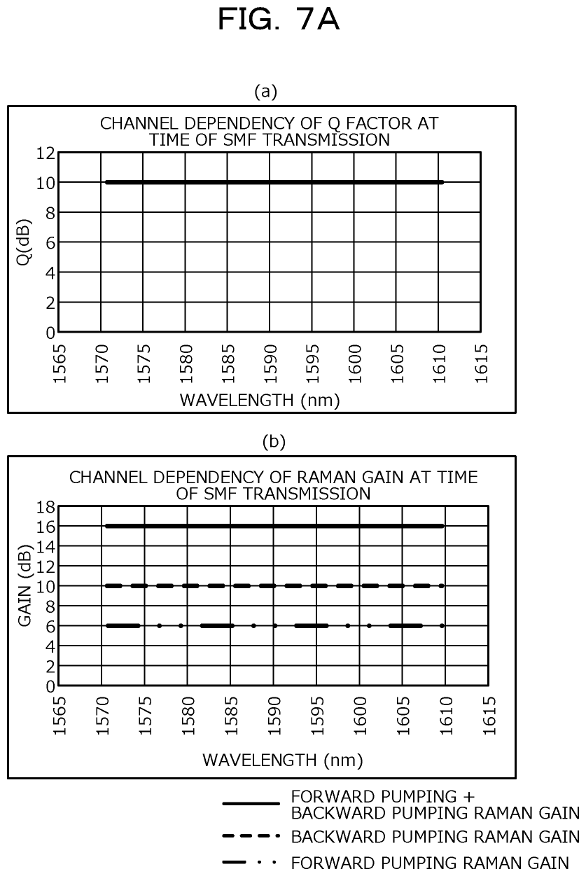

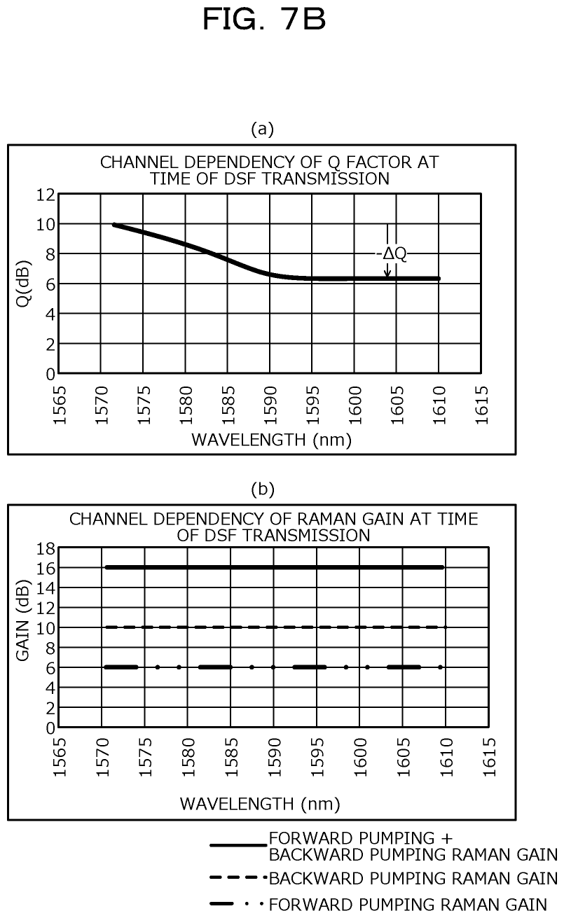

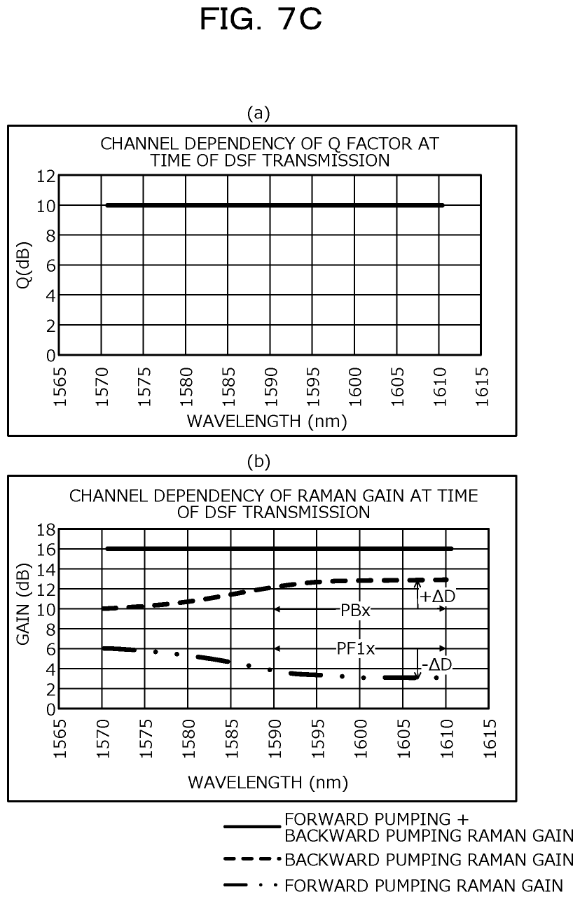

FIGS. 7A to 7C are tables illustrating deterioration in a Q factor and a Raman gain due to the XPM. The horizontal axis in the table in each of FIGS. 7A to 7C indicates a wavelength. The vertical axis of (a) of FIGS. 7A to 7C indicates a Q factor, and the vertical axis of (b) indicates a gain.

FIG. 7A(a) illustrates channel dependency of a Q factor at the time of SMF transmission. In a case of the SMF transmission, it is illustrated that XPM caused by pumping light does not occur and the channel dependency of the Q factor does not occur. FIG. 7A(b) illustrates channel dependency of a Raman gain at the time of the SMF transmission. It is illustrated that, in a case of the SMF transmission, in any one of only forward pumping, only backward pumping, and the forward pumping and the backward pumping, a gain of the entire wavelength band is flat, and the channel dependency of the Raman gain does not occur.

FIG. 7B(a) illustrates channel dependency of a Q factor at the time of DSF transmission. It is illustrated that, in a case of the DSF transmission, the XPM due to the pumping light occurs, and the Q factor gradually deteriorates toward the longer wavelength side, and deterioration by −ΔQ occurs in a wavelength equal to or more than 1600 nm. FIG. 7B(b) illustrates channel dependency of a Raman gain at the time of the DSF transmission. It is illustrated that, in a case of the DSF transmission, in any one of only forward pumping, only backward pumping, and the forward pumping and the backward pumping, a gain of the entire wavelength band is flat, and the channel dependency of the Raman gain does not occur.

FIG. 7C illustrates characteristics corresponding to Raman amplification control according to the embodiment, and FIG. 7C(a) illustrates channel dependency of a Q factor at the time of the DSF transmission. It is illustrated that, by quenching the longer wavelength side PF1x of the forward pumping light PF1 that causes the XPM in order to cope with the deterioration of the Q factor illustrated in FIG. 7B(a), the deterioration of the Q factor is eliminated, and the Q factor is flattened. FIG. 7C(b) illustrates channel dependency of a Raman gain at the time of the DSF transmission. By quenching the longer wavelength side PF1x of the forward pumping light PF1, a tilt occurs in which the Raman gain is gradually lowered as going toward the longer wavelength side of the forward pumping light PF1. In a case of FIG. 7C(b), the Raman gain is lowered by only −ΔD on the longer wavelength side PF1x that is equal to or more than 1600 nm.

Correspondingly, in the embodiment, the Raman gain on the longer wavelength side PBx of the backward pumping light PB is increased by only +ΔD. A tilt in which the Raman gain gradually increases as going toward the longer wavelength side PBx of the backward pumping light PB is caused. As a result, flatness of the Raman gain (solid line in FIG. 7C(b)) due to the forward pumping and the backward pumping can be secured, and the deterioration of the Q factor can be eliminated.

### Configuration Example of Embodiment

Next, each configuration example of the bidirectional Raman amplification system according to the embodiment will be described. In each of the configuration examples 1. to 3. below, the DSF 120 is used as the dispersion shifted fiber.

Configuration example 1. Configuration compatible with the DSF using general-purpose forward pumping Raman amplification.

Configuration example 2. Configuration of forward pumping Raman amplification compatible with the DSF (configuration example of forward pumping Raman that does not include longer-wavelength-side laser module, in consideration of effect of XPM caused in DSF).

Configuration example 3. Configuration that performs pumping control on multiple spans, using the general-purpose forward pumping Raman amplification, based on various types of information in multiple spans in an entire optical transmission line including information regarding a zero-dispersion wavelength.

### Configuration Example 1

The configuration example 1 performs pumping control compatible with the DSF using the general-purpose forward pumping Raman amplification. In this configuration example 1, pumping control for suppressing the effect of the XPM is performed based on the optical transmission characteristics (profile) unique to the DSF 120.

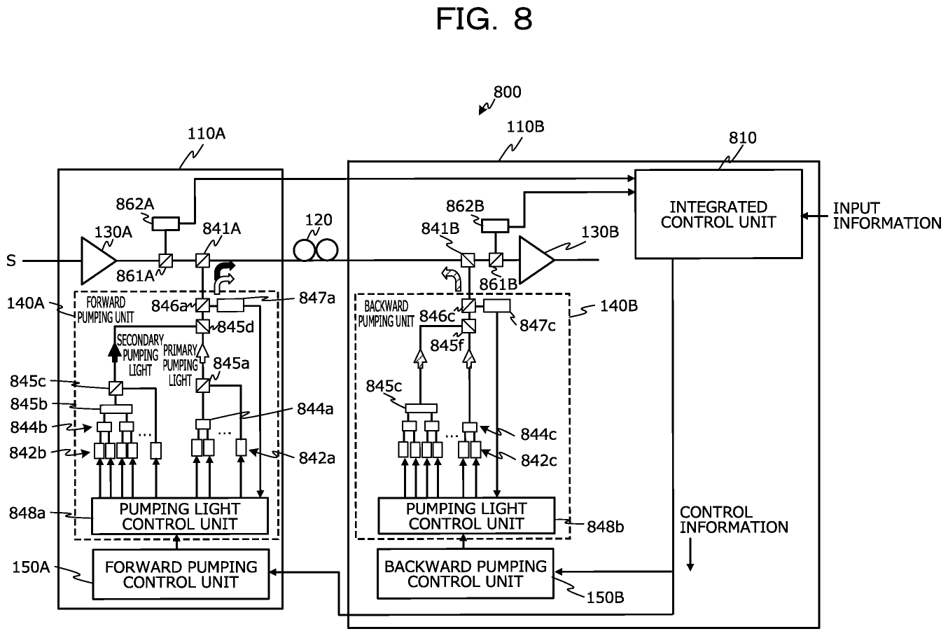

FIG. 8 is a diagram illustrating the configuration example 1 of the optical transmission system according to the embodiment. An example is illustrated in which an optical transmission system 800 of the configuration example 1 illustrated in FIG. 8 includes a pair of optical transmission devices 110A and 110B for one span on the optical transmission line 120. The upstream first optical transmission device 110A is coupled to one end of a DSF 120, and the downstream second optical transmission device 110B is coupled to another end of the DSF 120. The signal light S has a band of the L band.

The first optical transmission device 110A includes a forward pumping unit 140A. The second optical transmission device 110B includes a backward pumping unit 140B and an integrated control unit 810.

A configuration of the first optical transmission device 110A side will be described. The forward pumping unit 140A of the first optical transmission device 110A includes a primary pumping light source 842a that emits primary pumping light having a plurality of wavelengths according to a bandwidth of the signal light S, a polarization coupler 844a that synthesizes orthogonal polarized waves of the primary pumping light, and a multiplexing filter 845a that multiplexes the plurality of beams of primary pumping light.

Furthermore, the forward pumping unit 140A of the first optical transmission device 110A includes a secondary pumping light source 842b that emits a plurality of beams of secondary pumping light according to a bandwidth of the primary pumping light and a polarization coupler 844b that synthesizes the orthogonal polarized waves of the primary pumping light. Furthermore, the forward pumping unit 140A includes multiplexing filters 845b and 845c that multiplex a plurality of beams of secondary pumping light.

The primary pumping light and the secondary pumping light are multiplexed by a multiplexing filter 845d and multiplexed as forward pumping light for the signal light S on the DSF 120 via a multiplexer 841A.

Furthermore, output of the multiplexing filter 845d is demultiplexed and output to a pumping light monitor 847a by a demultiplexing filter 846a. The pumping light monitor 847a detects an output level of the forward pumping light and outputs the output level to a pumping light control unit 848a.

The pumping light control unit 848a controls output levels of the primary pumping light source 842a that is the forward pumping light and the secondary pumping light source 842b, based on the output level detected by the pumping light monitor 847a.

The forward pumping control unit 150A controls the pumping light control unit 848a and variably controls the output level of the forward pumping light by the forward pumping unit 140A. For example, the forward pumping control unit 150A performs control for reducing the gain of the longer wavelength side PF1x of the forward pumping light PF1 illustrated in FIG. 7C(b).

A configuration of the second optical transmission device 110B side will be described. The backward pumping unit 140B of the second optical transmission device 110B includes a pumping light source 842c that emits pumping light having a plurality of wavelengths according to the bandwidth of the signal light S, a polarization coupler 844c that polarizes and synthesizes pumping light, and a multiplexing filter 845c that multiplexes the pumping light.

The plurality of beams of pumping light is multiplexed by a multiplexing filter 845f and multiplexed as backward pumping light for the signal light S on the DSF 120 via a multiplexer 841B.

Furthermore, output of the multiplexing filter 845f is demultiplexed and output to a pumping light monitor 847c by a demultiplexing filter 846c. The pumping light monitor 847c detects an output level of the backward pumping light and outputs the output level to a pumping light control unit 848b.

The pumping light control unit 848b controls an output level of the pumping light source 842c based on the output level detected by the pumping light monitor 847c.

The backward pumping control unit 150B controls the pumping light control unit 848b and variably controls the output level of the backward pumping light by the backward pumping unit 140B. For example, the backward pumping control unit 150B performs control for increasing the gain on the longer wavelength side PBx of the backward pumping light PB illustrated in FIG. 7C(b).

The forward pumping control unit 150A and the backward pumping control unit 150B are coupled to the integrated control unit 810. The integrated control unit 810 integrates the variable control of the Raman gain performed by each of the forward pumping control unit 150A of the first optical transmission device 110A and the backward pumping control unit 150B of the second optical transmission device 110B. For example, the integrated control unit 810 is arranged in a terminal station for each span or several spans.

In the example in FIG. 8, the integrated control unit 810 is arranged in the second optical transmission device 110B. The embodiment is not limited to this, and the integrated control unit 810 may be arranged in the first optical transmission device 110A or may be mounted in both of the first optical transmission device 110A and the second optical transmission device 110B while dividing functions thereof.

In the configuration example in FIG. 8, the forward pumping control unit 150A of the first optical transmission device 110A and the backward pumping control unit 150B of the second optical transmission device 110B are electrically coupled to the integrated control unit 810 via a network other than the DSF 120. The embodiment is not limited to this, and the forward pumping control unit 150A and the backward pumping control unit 150B can include control information in optical supervisory channel (OSC) light, superimpose the light on the signal light S on the optical transmission line 120, and optically transmit the information. In this case, the forward pumping control unit 150A and the backward pumping control unit 150B can transmit and receive OSC information by branching or inserting the OSC light by a multiplexer or a demultiplexer (not illustrated) on the optical transmission line 120.

The integrated control unit 810 monitors power of the signal light S on the transmission side, for the first optical transmission device 110A. In the example in FIGS. 1A to IF, an output level of demultiplexing output of a demultiplexer 861A arranged at a preceding stage (upstream) of a multiplexing position of the forward pumping light on the side of the first optical transmission device 110A is monitored by a transmission-side signal light monitor 862A.

Furthermore, the integrated control unit 810 monitors power of the signal light S on the reception side, for the second optical transmission device 110B. In the example in FIGS. 1A to IF, an output level of demultiplexing output of a demultiplexer 861B arranged at a post-stage (downstream) of a multiplexing position of the backward pumping light on the side of the second optical transmission device 110B is monitored by a reception-side signal light monitor 862B.

In the integrated control unit 810, information such as monitor outputs of the transmission-side signal light monitor 862A and the reception-side signal light monitor 862B, and transmission characteristics (profile) unique to the DSF 120 is input. Furthermore, information regarding a span section, a fiber type, a zero-dispersion wavelength, a signal light band, a design Raman gain to be controlled is received.

The integrated control unit 810 has each of functions of input/output power wavelength characteristics monitoring, gain wavelength characteristics calculation, and gain calculation.

The integrated control unit 810 controls each of power of the forward pumping for the forward pumping control unit 150A and power of backward pumping for the backward pumping control unit 150B, based on these calculation results.

The integrated control unit 810 outputs the control information such as the fiber type, the gain wavelength characteristics, or a gain change instruction to the forward pumping control unit 150A of the first optical transmission device 110A side and the backward pumping control unit 150B of the second optical transmission device 110B side. For example, a pumping ratio table is set so as to set a different pumping ratio for a forward pumping light source depending on the fiber type.

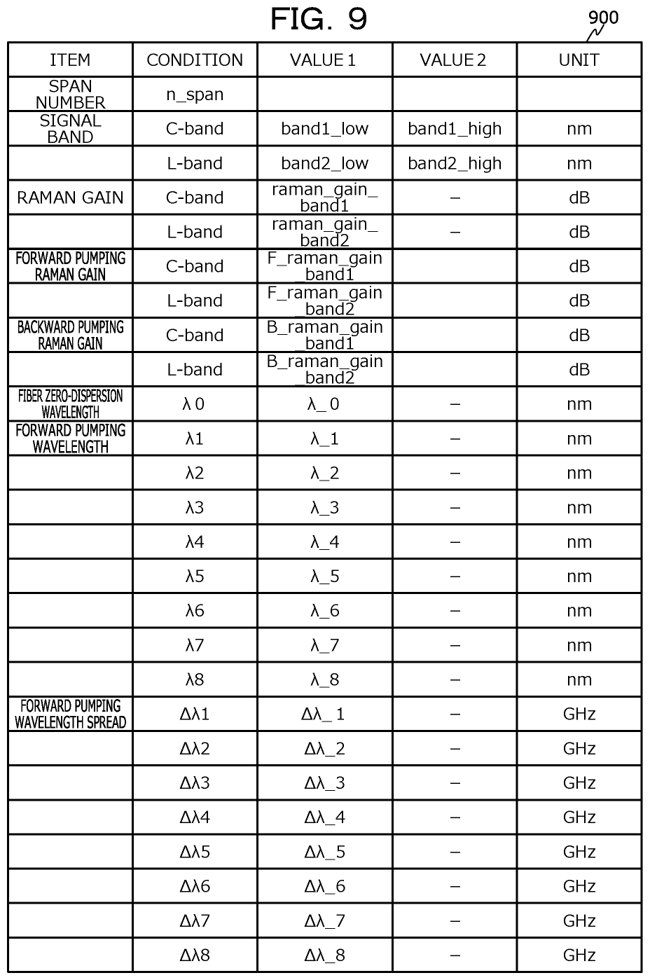

FIG. 9 is a table illustrating an example of an information table. The integrated control unit 810 holds information including a condition, a value, a unit, or the like for each item of a span number of one span, a signal band of the signal light S, a Raman gain, a forward pumping Raman gain, a backward pumping Raman gain, a fiber zero-dispersion wavelength, a forward pumping wavelength, and a forward pumping wavelength spread, as an information table 900.

This information table 900 is stored in a storage unit of the integrated control unit 810. To the signal band to the backward pumping Raman gain indicated in the example in FIG. 9, predetermined values corresponding to a C band and an L band of the signal light S are set. Furthermore, in the example in FIG. 9, it is illustrated that the forward pumping wavelength of the primary pumping light includes eight wavelengths λ1 to λ8 and the respective wavelengths λ1 to λ8 are forward pumping wavelength spreads λ1 to Δλ8, respectively.

Furthermore, the integrated control unit 810 calculates a span loss, a forward pumping Raman gain, a backward pumping Raman gain, and a total Raman gain (Raman gain), based on the monitor outputs of the transmission-side signal light monitor 862A and the reception-side signal light monitor 862B. The integrated control unit 810 sets the calculated value to a corresponding record in the information table 900.

The integrated control unit 810 calculates, for example, the span loss and the Raman gain as follows. Here, the transmission-side signal light monitor 862A monitor outputs a transmission signal light level (TX_mon), and the reception-side signal light monitor 862B monitor outputs a reception signal light level (Rx_mon).

The integrated control unit 810 obtains the span loss from the reception signal light level (Rx_mon)−the transmission signal light level (TX_mon) before the forward pumping unit 140A and the backward pumping unit 140B are activated.

The integrated control unit 810 obtains the backward pumping Raman gain by subtracting the span loss from the reception signal light level (Rx_mon)−the transmission signal light level (TX_mon) when only the backward pumping unit 140B is activated.

The integrated control unit 810 obtains the forward pumping Raman gain by subtracting the backward pumping Raman gain and the span loss from the reception signal light level (Rx_mon)−the transmission signal light level (TX_mon) after the forward pumping unit 140A and the backward pumping unit 140B are activated.

The integrated control unit 810 obtains the total Raman gain by subtracting the span loss from the reception signal light level (Rx_mon)−the transmission signal light level (TX_mon) after the forward pumping unit 140A and the backward pumping unit 140B are activated. After quenching the pumping light (forward pumping unit 140A) that causes the XPM or applying a low power ratio, the integrated control unit 810 calculates the total Raman gain.

After calculating the information regarding the pumping control described above, the integrated control unit 810 outputs the control information to each of the forward pumping unit 140A and the backward pumping unit 140B. The control information includes, for example, the calculated span loss, forward pumping Raman gain, and backward pumping Raman gain, and an instruction of a pumping ratio table to be adopted, in addition to the fiber type.

The integrated control unit 810 outputs a gain change instruction for lowering the pumping light power (quenching) that is a part (L band) of the forward Raman pumping light, to the forward pumping unit 140A. Furthermore, after outputting the control information, the integrated control unit 810 outputs a gain change instruction for increasing power of the backward Raman pumping light to the backward pumping unit 140B, until the total Raman gain becomes a required amount or deviation.

To lower the pumping power of a part of the forward pumping Raman or increase the pumping light power of a part of the backward pumping Raman can be achieved by individually changing setting a pumping laser. The embodiment is not limited to this, and this can be performed by applying a pumping light power ratio table for setting a ratio of output power of each pumping laser that has been designed in advance.

The forward pumping control unit 150A of the first optical transmission device 110A has a pumping light power ratio table for setting a ratio of pumping power on the shorter wavelength side (C band) and pumping power on the longer wavelength side (L band). The forward pumping control unit 150A refers to the pumping light power ratio table at the time of the output of the control information by the integrated control unit 810, determines pumping ratios and gains on the shorter wavelength side and the longer wavelength side, and controls the pumping light control unit 848a.

Similarly, the backward pumping control unit 150B of the second optical transmission device 110B has a pumping light power ratio table for setting a ratio of the pumping power on the shorter wavelength side (C band) and the pumping power on the longer wavelength side (L band). The backward pumping control unit 150B refers to the pumping light power ratio table at the time of the output of the control information by the integrated control unit 810, determines pumping ratios and gains on the shorter wavelength side and the longer wavelength side, and controls the pumping light control unit 848b.

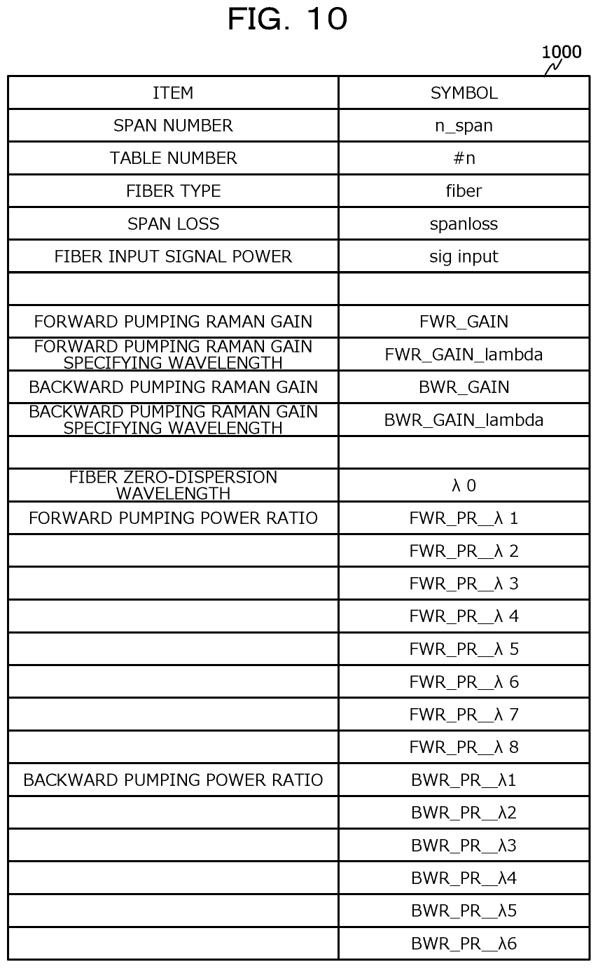

FIG. 10 is a table illustrating an example of a pumping light power ratio table. A pumping light power ratio table 1000 illustrated in FIG. 10 is held by the integrated control unit 810 in advance. The embodiment is not limited to this, and the pumping light power ratio table 1000 may be held by each of the storage units of the forward pumping control unit 150A on the first optical transmission device 110A side and the backward pumping control unit 150B on the second optical transmission device 110B side.

The pumping light power ratio table 1000 includes information such as a table number, a fiber type, a span loss, fiber input signal power, a Raman gain, a fiber zero-dispersion wavelength, a forward pumping power ratio, and a backward pumping power ratio, for each span number.

As described above, in a case of the DSF 120, the forward pumping quenches the power of the pumping light on the longer wavelength side or sets a small pumping power ratio, and the backward pumping sets a large pumping power ratio on the long wavelength side in order to compensate an insufficient gain of the forward pumping. The forward pumping power ratio and the backward pumping power ratio are set to each of the plurality of wavelengths λ1 to λ8 within a band.

Furthermore, to cope with a case where a forward Raman gain and a backward Raman gain are not flat as in the DSF 120, the forward pumping Raman gain is set to include a forward pumping Raman gain specifying wavelength for specifying a flat portion within the band. The backward pumping Raman gain is set to include a backward pumping Raman gain specifying wavelength for specifying a flat portion within the band.

The integrated control unit 810 refers to the pumping light power ratio table 1000 and outputs a gain control instruction for gradually lowering the gain on the longer wavelength side in correspondence with the forward pumping power ratio of each of the wavelengths λ1 to λ8 for each table number, to the forward pumping control unit 150A.

Furthermore, the integrated control unit 810 refers to the pumping light power ratio table 1000, and outputs a gain control instruction for gradually increasing the gain on the longer wavelength side in correspondence with the backward pumping power ratio of each of the wavelengths λ1 to λ8 for each table number, to the backward pumping control unit 150B.

(Hardware Configuration Example of Control Unit of Optical Transmission Device)

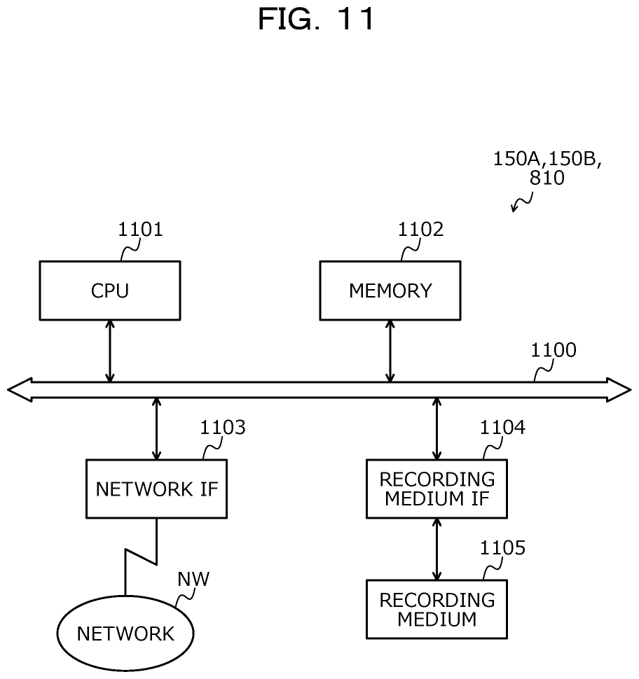

FIG. 11 is a diagram illustrating a hardware configuration example of a control unit of an optical transmission device. For example, each of the forward pumping control unit 150A of the first optical transmission device 110A, the backward pumping control unit 150B of the second optical transmission device 110B, and the integrated control unit 810 can be configured with hardware illustrated in FIG. 11.

For example, the forward pumping control unit 150A includes
a processor 1101 such as a central processing unit (CPU), a memory 1102, a network IF 1103, a recording medium IF 1104, and a recording medium 1105. Furthermore, each component is coupled with a bus 1100, respectively.

Here, the processor 1101 is a control unit that controls the entire forward pumping control unit 150A. The processor 1101 may include a plurality of cores. The memory 1102 includes, for example, a read only memory (ROM), a random access memory (RAM),
a flash ROM, or the like. For example, the flash ROM stores a control program, the ROM stores an application program, and the RAM is used as a work area for the processor 1101. The program stored in the memory 1102 causes the processor 1101 to execute coded processing by being loaded on the processor 1101.

The network IF 1103 manages an interface between a network NW and an inside of a device, and controls input/output of information between another backward pumping control unit 150B and the integrated control unit 810.

The recording medium IF 1104 controls reading/writing of data from/to the recording medium 1105 under the control of the processor 1101. The recording medium 1105 stores data written under the control of the recording medium IF 1104.

Note that the forward pumping control unit 150A can be coupled to, for example, an input device, a display, or the like via an IF, in addition to the components described above.

The processor 1101 illustrated in FIG. 11 can realize the function of the forward pumping control unit 150A illustrated in FIG. 8 or the like, by executing the program.

Furthermore, the network IF 1103 illustrated in FIG. 11 may include an optical transmission line, in addition to communication using electric signals. The forward pumping control unit 150A and the backward pumping control unit 150B illustrated in FIG. 8 may include the optical transmission line 120 for partial transmission/reception of the control information to/from the integrated control unit 810. For example, it is possible to include the control information output from the integrated control unit 810 into the OSC and to multiplex the OSC with the signal light S with the multiplexer on the optical transmission line 120 toward the sides of the forward pumping control unit 150A and the backward pumping control unit 150B and transmit the OSC.

Furthermore, as in the example illustrated in FIG. 8, in a case where the optical transmission line 120 that is a target section is one span, for example, the function of the integrated control unit 810 may be integrated with the backward pumping control unit 150B of the second optical transmission device 110B. In this case, the control unit on the second optical transmission device 110B side controls the forward pumping control unit 150A of the first optical transmission device 110A. Moreover, in a case where the optical transmission line 120 that is the target section includes the plurality of spans, for example, the function of the integrated control unit 810 may be integrated with the backward pumping control unit 150B of the optical transmission device 110 at the final stage (most downstream).

### Pumping Light Control Example of Configuration Example 1

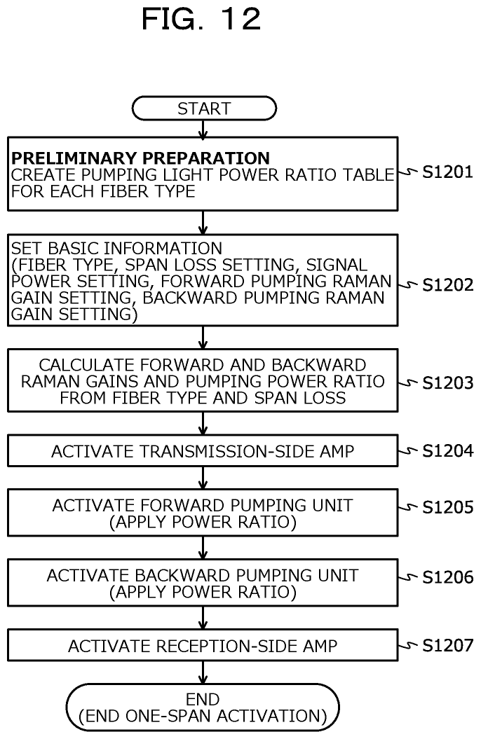

FIG. 12 is a flowchart illustrating a pumping light control example according to the configuration example 1. FIG. 12 illustrates integrated control mainly performed by the integrated control unit 810. Under the integrated control of the integrated control unit 810, the forward pumping control unit 150A and the backward pumping control unit 150B control pumping light power in cooperation.

As a preliminary preparation, the integrated control unit 810 creates the pumping light power ratio table 1000 for each fiber type (step S1201). As illustrated in FIG. 10, in a case of the DSF 120, the pumping light power ratio table 1000 includes the forward pumping power ratio for lowering the power on the longer wavelength side of the forward pumping Raman and the backward pumping power ratio for compensating the gain wavelength characteristics that lower the longer wavelength of the forward pumping Raman.

Then, the integrated control unit 810 sets basic information of pumping light control for one target span (refer to FIG. 8) (step S1202). The integrated control unit 810 sets the basic information, based on input information input into the integrated control unit 810. The input information is a fiber type, a fiber zero-dispersion wavelength, a signal light band, or the like. The integrated control unit 810 sets the span number, the signal band, the Raman gain, the forward pumping Raman gain, the backward pumping Raman gain, the fiber zero-dispersion wavelength, the forward pumping wavelength, and the backward pumping wavelength, to the information table 900 in FIG. 9, based on the input information. For example, the integrated control unit 810 sets a calculated value based on measurement as described above, as the Raman gain.

Next, the integrated control unit 810 calculates a gain of the forward Raman, a gain of the backward Raman, and a pumping power ratio from the fiber type and the span loss. Then, the integrated control unit 810 outputs the control information of the pumping light to each of the forward pumping control unit 150A and the backward pumping control unit 150B (step S1203).

Next, the integrated control unit 810 performs control for activating the optical amplifier 130A on the transmission side (first optical transmission device 110A) (step S1204). Next, the integrated control unit 810 performs control for activating the forward pumping unit 140A (step S1205). At this time, the forward pumping control unit 150A performs forward pumping to which the pumping power ratio is applied.

Next, the integrated control unit 810 performs control for activating the backward pumping unit 140B (step S1206). At this time, the backward pumping control unit 150B performs backward pumping to which the pumping power ratio is applied.

Next, the integrated control unit 810 performs control for activating the optical amplifier 130B on the reception side (second optical transmission device 110B) (step S1207) and ends the one-span activation processing as described above.

According to the configuration example 1, it is possible to avoid the effect of the XPM in a case where the optical transmission line is the DSF 120 while using the general-purpose forward pumping Raman amplification, and it is possible to prevent the deterioration in the signal quality of the signal light S.

### Configuration Example 2

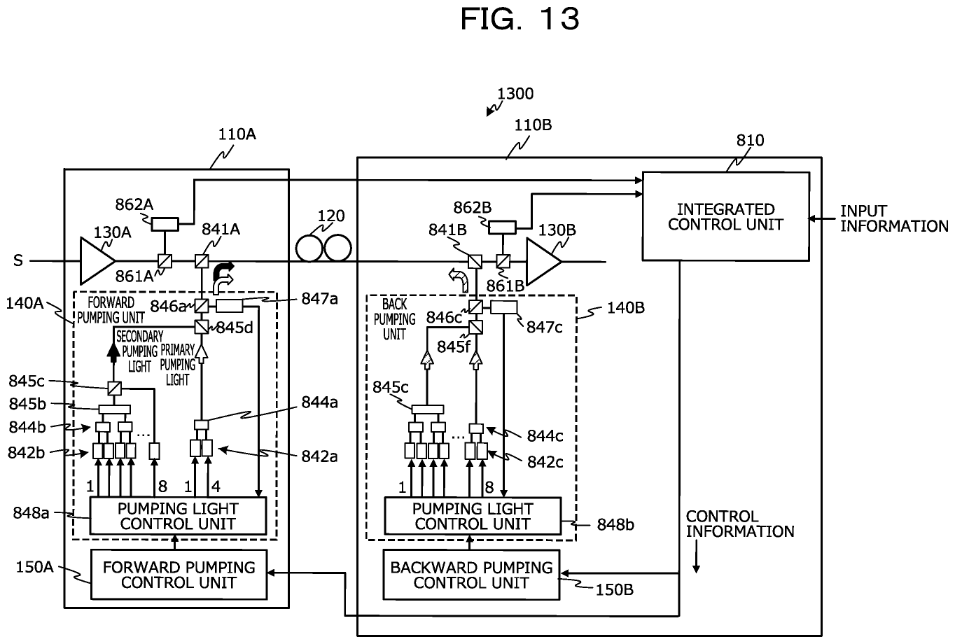

FIG. 13 is a diagram illustrating the configuration example 2 of the optical transmission system according to the embodiment. In an optical transmission system 1300 of the configuration example 2, a component same as that in the configuration example 1 illustrated in FIG. 8 is denoted with the same reference numeral, and description thereof is omitted. The configuration example 2 is different from the configuration example 1 in that a laser module on the longer wavelength side of the forward pumping unit 140A is not mounted, in consideration of the effect of the XPM caused in the DSF 120. As illustrated in FIG. 13, in the configuration example 2, the only four primary pumping light sources 842a of the forward pumping unit 140A on the shorter wavelength side (λ1 to λ4) in the band are provided, and the four primary pumping light sources 842a on the longer wavelength side (λ5 to λ8) are not provided. As described in the configuration example 1, the primary pumping light sources 842a on the longer wavelength side perform quenching control, the primary pumping light sources 842a on the longer wavelength side are not provided in the configuration example 2.

Note that both of the number of secondary pumping light sources 842b of the primary pumping light source 842a of the forward pumping unit 140A and the pumping light sources 842c of the backward pumping unit 140B are eight (same as that in configuration example 1).

In the configuration example 2, the integrated control unit 810 may be arranged in the second optical transmission device 110B, may be arranged in the first optical transmission device 110A, or may be mounted in both of the first optical transmission device 110A and the second optical transmission device 110B while dividing the functions.

### Pumping Light Control Example of Configuration Example 2

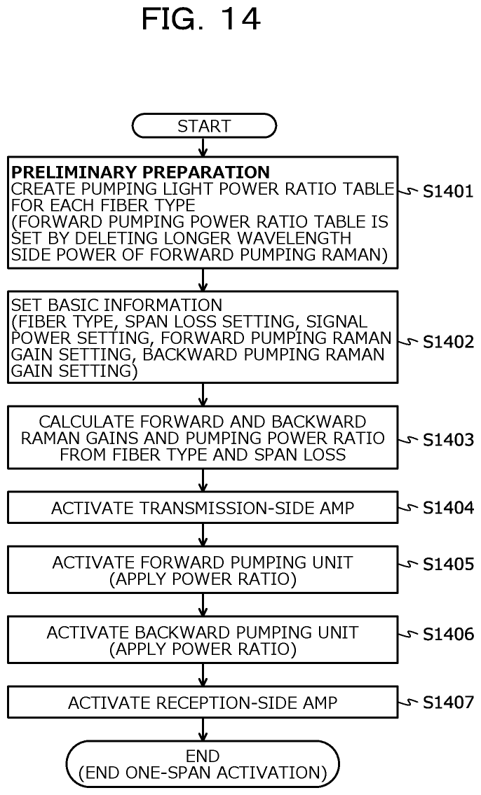

FIG. 14 is a flowchart illustrating a pumping light control example according to the configuration example 2. Processing illustrated in FIG. 14 is almost similar to that in the configuration example 1, and step S1402 to step S1407 in the configuration example 2 (FIG. 14) are similar to step S1202 to step S1207 in the configuration example 1 (FIG. 12).

In the configuration example 2, processing in step S1401 is different from that in the configuration example 1. As a preliminary preparation of step S1401, the integrated control unit 810 creates the pumping light power ratio table 1000 for each fiber type. In a case where the fiber type is the DSF 120, the pumping light power ratio table 1000 illustrated in FIG. 10 includes the forward pumping power ratio for lowering the power on the longer wavelength side of the forward pumping Raman and the backward pumping power ratio for compensating the gain wavelength characteristics that lowers the longer wavelength of the forward pumping Raman.

In the configuration example 2, the primary pumping light source 842a on the longer wavelength side is not provided. Therefore, the integrated control unit 810 performs forward pumping to which the forward pumping power ratio is applied, only on the forward pumping ratio power on the shorter wavelength side (λ1 to λ4) of the forward pumping Raman illustrated in FIG. 10, in the pumping light power ratio table 1000.

According to the configuration example 2, it is possible to avoid the effect of the XPM in a case where the optical transmission line is the DSF 120, and it is possible to prevent the deterioration in the signal quality of the signal light S. Furthermore, in the configuration example 2, the configuration does not have the primary pumping light source 842a on the longer wavelength side, in consideration of the effect of the XPM caused in the DSF 120. Therefore, it is possible to reduce the number of primary pumping light sources in the forward pumping as compared with the configuration example 1.

### Configuration Example 3

The configuration examples 1 and 2 described above are configurations that perform pumping control by applying the pumping light ratio, using a fiber parameter included in a typical optical transmission line 120 and a preset value of a Raman pumping configuration. On the other hand, the configuration example 3 is a configuration that determines a wavelength that is actually controlled from zero-dispersion wavelength information or the like and performs pumping control in correspondence with variations of various parameters.

The configuration example 3 has a multi-span system configuration that measures an error rate of a main signal (signal light S) in order to determine whether or not a pumping light ratio is optimal and includes the most upstream transmitter to the most downstream receiver that are arranged on the optical transmission line 120.

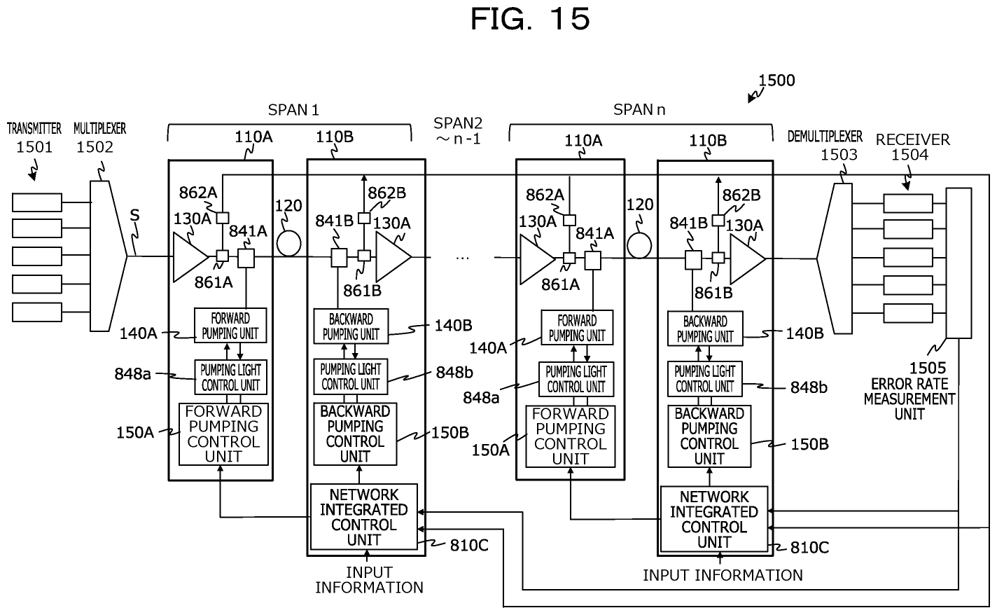

FIG. 15 is a diagram illustrating the configuration example 3 of the optical transmission system according to the embodiment. In an optical transmission system 1500 illustrated in FIG. 15, an example is illustrated in which the span indicated in the configuration example 1 (FIG. 8) or the like is a plurality of spans, and for convenience, the forward pumping unit 140A (first optical transmission device 110A) and the backward pumping unit 140B (second optical transmission device 110B) are arranged for each span. Furthermore, in FIG. 15, a component similar to that in the configuration example 1 (FIG. 8) is denoted with a similar reference numeral, and component portions of spans 2 to n−1 are omitted.

In the configuration example 3, network integrated control units 810C of a network management system (NMS) are arranged in a second optical transmission device 110B of the span 1 and a second optical transmission device 110B of the span n.

In FIG. 15, on the most upstream of the optical transmission line 120, for example, a preceding stage (upstream) of the span 1, a plurality of transmitters 1501 and a multiplexer 1502 that multiplexes beams of signal light having different wavelengths output from the plurality of transmitters 1501 and outputs the signal light to the optical transmission line 120 as the signal light S are arranged.

Furthermore, on the most downstream of the optical transmission line 120, for example, the post-stage (downstream) of the span n, a demultiplexer 1503 that demultiplexes the optical transmission line 120 for each wavelength and a receiver 1504 that receives the demultiplexed signal light with each wavelength are arranged. Furthermore, an error rate measurement unit 1505 that measures a signal error rate at the time when each of the plurality of receivers 1504 receives a signal is provided, and information regarding the signal error rate of the error rate measurement unit 1505 is output to the integrated control unit 810. The error rate measurement unit 1505 may be included in each receiver 1504.

Monitor outputs of the transmission-side signal light monitor 862A and the reception-side signal light monitor 862B of the span indicated in the configuration example 1, for a plurality of spans, are input into the integrated control unit 810. The integrated control unit 810 sequentially performs pumping light control on the span 1 on the upstream side to the span n on the downstream side, based on the input information similar to that in the configuration example 1, the monitor information of the transmission-side signal light monitor 862A and the reception-side signal light monitor 862B for each span, and the information such as the signal error rate.

The integrated control unit 810 executes each of processing 1. to processing 4. below, as an outline, in a Raman amplification method in the configuration example 3.

1. Creation of pumping light power ratio table for each span 2. Extraction of pumping light that causes XPM deterioration in each span 3. Application and adjustment of pumping light power ratio table to each span 4. Evaluation and optimization using signal error rate (application of new pumping light ratio table when improvement is insufficient)

Hereinafter, each processing will be described.

### 1. Creation of Pumping Light Power Ratio Table for Each Span

In the configuration example 3, the integrated control unit 810 creates the plurality of pumping light power ratio tables 1000 for each span.

### 2. Extraction of Pumping Light Causing XPM Deterioration of Each Span

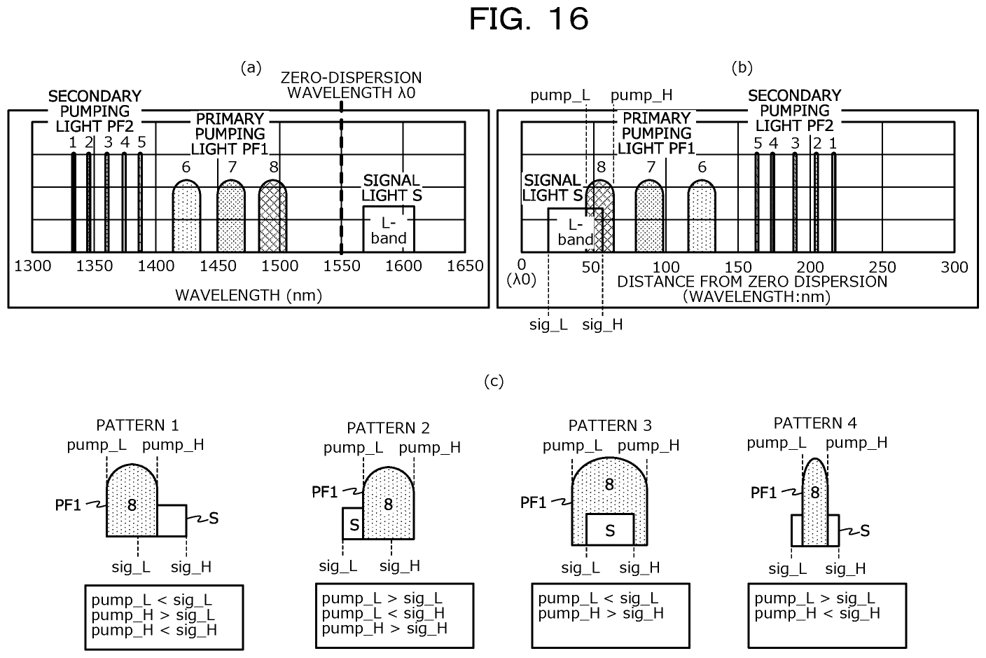

FIG. 16 is a diagram for explaining extraction of signal light and pumping light of XPM deterioration. FIG. 16(a) illustrates arrangement of the signal band (L band) of the signal light S and the pumping light, the horizontal axis indicates a wavelength, and the vertical axis indicates optical power. For convenience, numbers λ1 to λ5 are given to respective wavelengths (λ) from the shorter wavelength side of the secondary pumping light to the longer wavelength side, and numbers λ6 to λ8 are given to respective wavelengths (λ) from the shorter wavelength side of the primary pumping light to the longer wavelength side.

Furthermore, FIG. 16(b) is a diagram in which the signal band (L band) of the signal light S and the pumping light illustrated in FIG. 16(a) are rearranged at distances from the zero-dispersion wavelength. The horizontal axis indicates a distance (wavelength) from the zero-dispersion wavelength, and the left end of the horizontal axis is set to zero.

As illustrated in FIG. 16(b), a signal with each wavelength in FIG. 16(a) is folded at the zero-dispersion wavelength λ0. In the example in FIG. 16(b), it is illustrated that a wavelength of the L band on the longer wavelength side of the signal light S overlaps primary pumping light of Δ8 on the longer wavelength side among the primary pumping light PF1.

FIG. 16(c) is a diagram illustrating each of patterns 1 to 4 for each overlapping state between the signal light S and the primary pumping light PF1. It is illustrated that the primary pumping light (λ8) has a wavelength that overlaps the band of the signal light S and causes the XPM. In a case where the primary pumping light PF1 is folded at the zero-dispersion wavelength λ0, the following four patterns of the primary pumping light PF1 and the band of the signal light S overlapping with each other are considered. Overlapping states of these can be determined by comparing the band of the signal light S with the spectral spread of the primary pumping light PF1.

A lower limit and an upper limit of the band of the signal light S are set as sig_L and sig_H based on the distance from the zero-dispersion wavelength λ0, and a lower limit and an upper limit of a spectrum of the primary pumping light PF1 (λ8) are set as pump_L and pump_H based on the distance from the zero-dispersion wavelength λ0. In this case, any one of the overlapping states in the following patterns 1 to 4 occurs.

The pattern 1 is a state where the primary pumping light PF1 overlaps the shorter wavelength side of the signal light S. The overlapping state is positioned at the lower limit (pump_L) of the primary pumping light PF1 (λ8)<the lower limit (sig_L) of the signal light S and is positioned at the upper limit (pump_H) of the primary pumping light PF1 (λ8)>the lower limit (sig_L) of the signal light S. Moreover, the overlapping state is positioned at the upper limit (pump_H) of the primary pumping light PF1 (λ8)<the upper limit (sig_H) of the signal light S.

The pattern 2 is a state where the primary pumping light PF1 overlaps the longer wavelength side of the signal light S. The overlapping state is positioned at the lower limit (pump_L) of the primary pumping light PF1 (λ8)>the lower limit (sig_L) of the signal light S and is positioned at the lower limit (pump_L) of the primary pumping light PF1 (λ8)<the upper limit (sig_H) of the signal light S. Moreover, the overlapping state is positioned at the upper limit (pump_H) of the primary pumping light PF1 (λ8)>the upper limit (sig_H) of the signal light S.

The pattern 3 is a state where the band of the primary pumping light PF1 is wider than the band of the signal light S and the primary pumping light PF1 covers the band of the signal light S. The overlapping state is positioned at the lower limit (pump_L) of the primary pumping light PF1 (λ8)<the lower limit (sig_L) of the signal light S and is positioned at the upper limit (pump_H) of the primary pumping light PF1 (λ8)>the upper limit (sig_H) of the signal light S.

The pattern 4 is a state where the band of the primary pumping light PF1 is narrower than the band of the signal light S. The overlapping state is positioned at the lower limit (pump_L) of the primary pumping light PF1 (λ8)>the lower limit (sig_L) of the signal light S and is positioned at the upper limit (pump_H) of the primary pumping light PF1 (λ8)<the upper limit (sig_H) of the signal light S.

As indicated in these patterns 1 to 4, between the signal light S and the primary pumping light PF1 (λ8), a different overlapping state is caused depending on the center wavelength and the spectral spread state of the primary pumping light PF1, respectively.

By calculating the states of the patterns 1 to 4, the integrated control unit 810 can find the primary pumping light PF1 that causes the XPM. In reality, regarding the band of the signal light S and the spectrum spread of the primary pumping light PF1, the patterns 1 and 2 described above are applied in most cases.

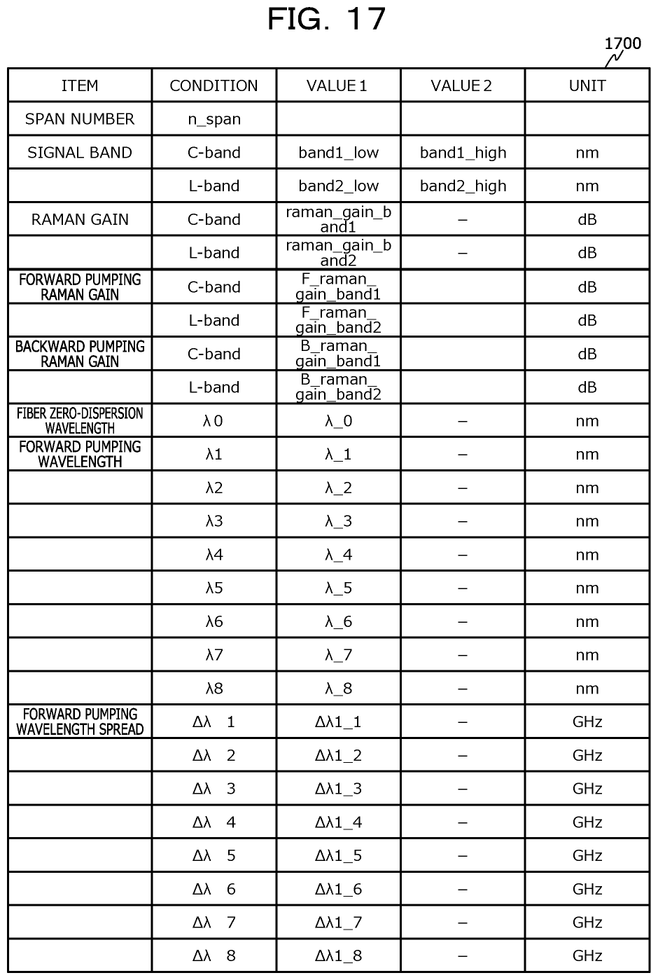

FIG. 17 is a table illustrating an example of an information table according to the configuration example 3. In the configuration example 3, the integrated control unit 810 holds information similar to that in the configuration example 1 (FIG. 9) for each span number, as an information table 1700. For example, the information table 1700 holds information such as a condition, a value, or a unit for each item of a span number, a signal band of the signal light S, a Raman gain, a forward pumping Raman gain, a backward pumping Raman gain, a fiber zero-dispersion wavelength, a forward pumping wavelength, and a forward pumping wavelength spread.

Here, the integrated control unit 810 sets the conditions described above, for example, in a case where

1. the lower limit and the upper limit of the band of the signal light S are set as the distances from the zero-dispersion wavelength λ0: sig_L and sig_H, and

2. the lower limit and the upper limit of the spectrum of the primary pumping light PF1 are set as distances from the zero-dispersion wavelength: pump_L and pimp_H, and in a case where the band of the signal band of the signal light S is the c band, in the information table 1700 illustrated in FIG. 17,

as c-band_sig_L=band1_low−λ_0 and

c-band_sig_H=band1_high−λ_0.

Furthermore, for each forward pumping wavelength of the primary pumping light PF1 of the forward pumping, for example, the wavelength λ1 is set as assuming that

λ1_pump_L=λ_1−Δλ_1−λ_0 and

λ1_pump_H=λ_1+Δλ_1−λ_0.

### 3. Application And Adjustment of Pumping Light Power Ratio Table to Each Span

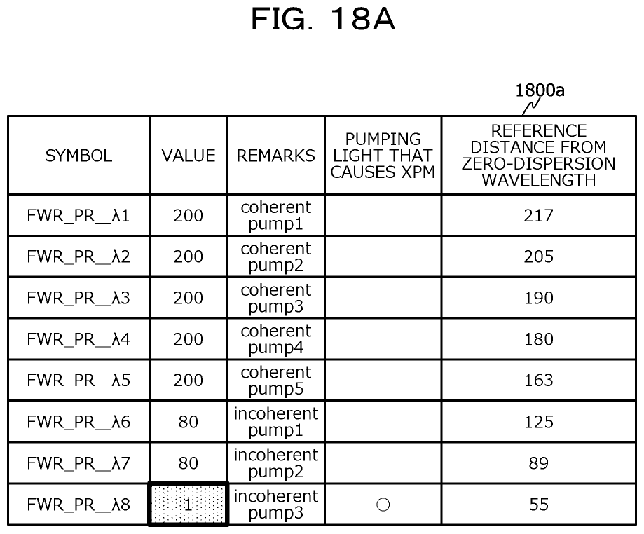

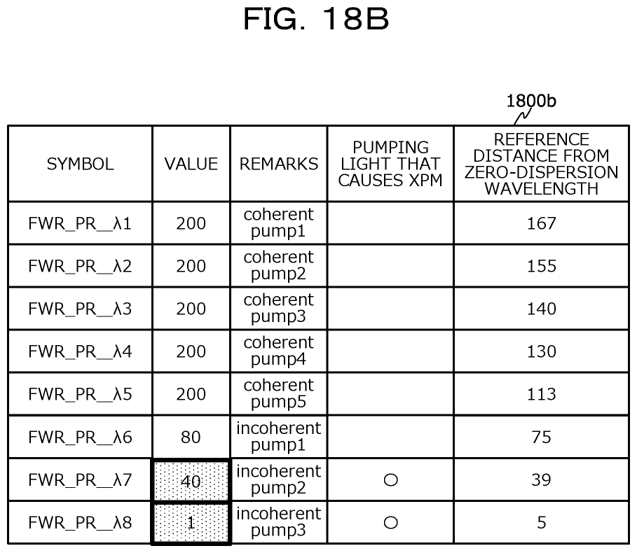

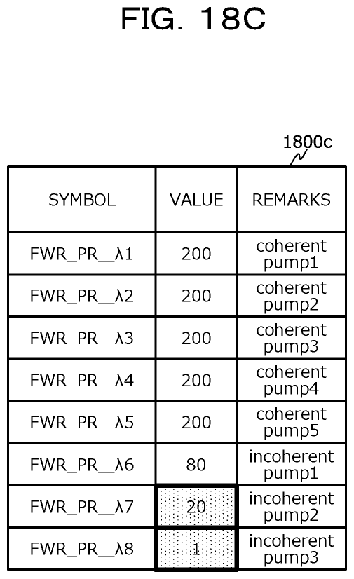

FIGS. 18A to 18C are tables illustrating a transmission-side pumping light power ratio table according to the configuration example 3. In a transmission-side pumping light power ratio table 1800a in FIG. 18A, an example in a case where only one beam of the primary pumping light of the forward pumping that causes the XPM is detected for the band of the signal light S is illustrated. The transmission-side pumping light power ratio table 1800a includes information regarding a symbol (forward pumping light power ratio), a value, a remark (information about coherent light/incoherent light), and whether or not there is pumping light that causes the XPM (O: pumping light that causes XPM). In FIG. 18A, a distance from the zero-dispersion wavelength λ0 is illustrated for reference.

As illustrated in FIG. 18A, in a case where the number of beams of primary pumping light (λ8) that causes the XPM for the band of the signal light S is one, the integrated control unit 810 selects the wavelength λ8 (FWR_PR_λ8) having the smallest value indicating the power ratio of the primary pumping light (smallest value that can be designed).

In a transmission-side pumping light power ratio table 1800b in FIG. 18B, an example in a case where two beams of the primary pumping light (λ7, λ8) that cause the XPM are detected for the band of the signal light S is illustrated. In a case where the plurality of beams of primary pumping light is detected, for example, the integrated control unit 810 changes the power ratio of the primary pumping light (λ7) closest to the zero-dispersion wavelength λ0 to 50% (value is changed 80→40).

After the setting in FIG. 18B, the integrated control unit 810 may determine the power ratio again based on an improvement state of deterioration caused by the XPM to be described later. For example, it is assumed that the deterioration caused by the XPM be not improved with the setting in FIG. 18B. In this case, as illustrated in a transmission-side pumping light ratio power table 1800c in FIG. 18C, the integrated control unit 810 changes the power ratio of the primary pumping light (λ7) closest to the zero-dispersion wavelength λ0 from 50% to 25%, for the two beams of the primary pumping light (λ7, λ8). For example, the value is changed 40→20.

There is a possibility that the primary pumping light closer to the zero-dispersion wavelength λ0 causes larger XPM deterioration. Therefore, the integrated control unit 810 suppresses the effect of the primary pumping light caused by the wavelength close to the zero-dispersion wavelength λ0 as possible. However, the integrated control unit 810 determines the improvement state by changing the power ratio as 50%→25%, in consideration of the reduction of the gain for the primary pumping light that secondarily affects. In this case, the plurality of pumping light power ratio tables 1800a to 1800c illustrated in FIGS. 18A to 18C are distinguished by applying a table number for each power ratio of the primary pumping light. The integrated control unit 810 selects the pumping light power ratio table 1800 having the table number corresponding to the power ratio of the primary pumping light.

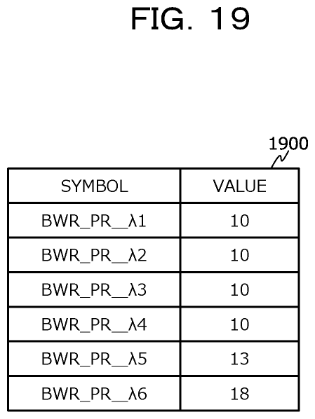

FIG. 19 is a table illustrating a reception-side pumping light power ratio table according to the configuration example 3. A reception-side pumping light power ratio table 1900 in FIG. 19 is created in advance, in correspondence with the transmission-side pumping light power ratio table 1800 illustrated in FIG. 18, assuming that the gain wavelength characteristics are to be compensated. The integrated control unit 810 selects the reception-side pumping light power ratio table 1900 corresponding to the selected transmission-side pumping light power ratio table 1800.

In the example of the reception-side pumping light power ratio table 1900 illustrated in FIG. 19, corresponding to a case where the number of beams of primary pumping light (λ8) of the forward pumping that causes the XPM is one, power ratios of the wavelengths λ5 and λ6 of the backward pumping corresponding to the wavelength λ8 are set to be large.

### 4. Evaluation and Optimization Using Signal Error Rate

In the adjustment of the primary pumping light, it is desired to confirm improvement in signal error rate characteristics. However, in a case where the forward pumping Raman and the backward pumping Raman are applied to multiple spans, there is a possibility that the error rate is too high and measurement cannot be performed if evaluation using the pumping light power ratio tables 1800 and 1900 described above (FIG. 18A to FIG. 19) is not applied. Therefore, in the configuration example 3, after performing the evaluation using the pumping light power ratio table for the forward and backward pumping Ramans of all the spans, the integrated control unit 810 performs evaluation and optimization using the signal error rate in a case where there is room for optimizing the pumping light ratio.

For example, in a case where there are two primary pumping wavelengths that cause the XPM, the integrated control unit 810 quenches the primary pumping wavelength close to the zero-dispersion wavelength λ0, of the primary pumping wavelength that causes the XPM, in the transmission-side pumping light power ratio table 1800 (sufficiently reduce power ratio). However, the integrated control unit 810 changes the power ratio of the primary pumping wavelength secondarily closest to the zero-dispersion wavelength as 50%→25% and optimizes the signal error rate.

### Pumping Light Control Example of Configuration Example 3

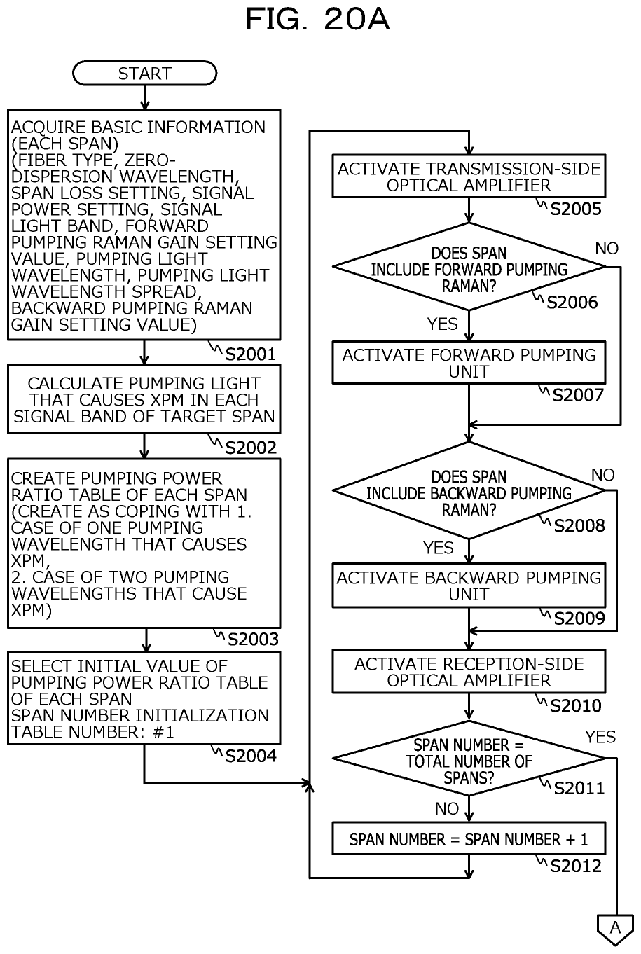

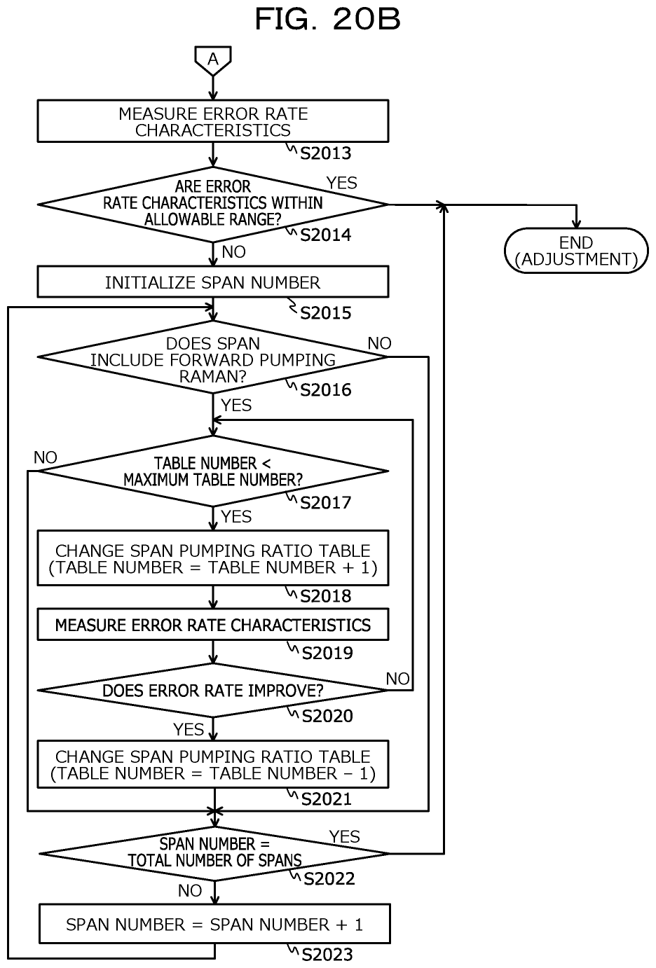

FIGS. 20A and 20B are flowcharts illustrating a pumping light control example according to the configuration example 3. FIGS. 20A and 20B illustrate an integrated control example mainly performed by the integrated control unit 810. The integrated control unit 810 controls the pumping light power for the forward pumping control unit 150A and the backward pumping control unit 150B of the span 1 in ascending order of the plurality of spans 1 to n. Thereafter, the integrated control unit 810 controls the pumping light power for and subsequent to the span 2 and finally controls the pumping light power for the span n.

As a preliminary preparation, the integrated control unit 810 creates a pumping light power ratio table for each fiber type (step S2001). At this time, the integrated control unit 810 creates the pumping light power ratio table for each fiber type and each of the spans 1 to n. The pumping light power ratio table includes the transmission-side pumping light power ratio table 1800 illustrated in FIG. 18A or the like and the reception-side pumping light power ratio table 1900 illustrated in FIG. 19.

Next, the integrated control unit 810 calculates pumping light that causes the XPM in a signal band of a target span (step S2002). The integrated control unit 810 calculates the pumping light that causes the XPM in the signal band of the target span, through the processing described with reference to FIG. 16.

Next, the integrated control unit 810 creates the pumping power ratio table for each span (step S2003). Here, the integrated control unit 810 creates the transmission-side pumping light power ratio table 1800 illustrated in FIG. 18A and the reception-side pumping light power ratio table 1900 illustrated in FIG. 19.

In step S2003, the integrated control unit 810 creates the pumping power ratio table for each span corresponding to 1. a case of one pumping wavelength that causes the XPM and 2. a case of two pumping wavelengths that cause the XPM.

### 1. Case of One Pumping Wavelength That Causes XPM

The integrated control unit 810 creates a power ratio table of which a pumping wavelength ratio of the wavelength is sufficiently reduced, for the forward pumping Raman. The integrated control unit 810 creates a power ratio table that compensates the gain wavelength characteristics of the forward pumping, for the backward pumping Raman.

### 2. Case of Two Pumping Wavelength That Cause XPM

For the forward pumping Raman, the integrated control unit 810 sufficiently reduces a pumping wavelength ratio of the wavelength close to the zero-dispersion wavelength and sets a power ratio of a wavelength secondarily close to the zero dispersion to, for example, 50%, 25%, and 10%. Here, the integrated control unit 810 separately sets a table number 1 to a table having the power ratio of 50% and sets a table number 2 to a table having the power ratio of 25%, for example. Furthermore, the integrated control unit 810 creates the power ratio table that compensates the gain wavelength characteristics of the forward pumping, for the backward pumping Raman.

Next, the integrated control unit 810 selects a pumping power ratio of a target span and an initial value of the table (step S2004). For example, the integrated control unit 810 initializes the span number at the time of processing start and selects a table number #1 of the corresponding information table 1700, transmission-side pumping light power ratio table 1800, and reception-side pumping light power ratio table 1900. Thereafter, the integrated control unit 810 increments the span number at the time when the span is selected again.

Next, the integrated control unit 810 activates the transmission-side optical amplifier 130A (step S2005). Next, the integrated control unit 810 determines whether or not the span includes the forward pumping Raman (step S2006). In a case where the span includes the forward pumping Raman (step S2006: Yes), the integrated control unit 810 proceeds to processing in step S2007, and in a case where the span does not include the forward pumping Raman (step S2006: No), the integrated control unit 810 proceeds to processing in step S2008.

In step S2007, the integrated control unit 810 performs control for activating the forward pumping unit 140A of the span (step S2007). At this time, the forward pumping control unit 150A performs forward pumping to which the pumping power ratio is applied.

Thereafter, in step S2008, the integrated control unit 810 determines whether or not the span includes the backward pumping Raman (step S2008). In a case where the span includes the backward pumping Raman (step S2008: Yes), the integrated control unit 810 proceeds to processing in step S2009, and in a case where the span does not include the backward pumping Raman (step S2008: No), the integrated control unit 810 proceeds to processing in step S2010.

In step S2009, the integrated control unit 810 performs control for activating the backward pumping unit 140B (step S2009). At this time, the backward pumping control unit 150B performs backward pumping to which the pumping power ratio is applied. Thereafter, in step S2010, the integrated control unit 810 activates the reception-side optical amplifier 130B (step S2010).

Next, the integrated control unit 810 determines whether or not the span number reaches the total number of spans (step S2011). If the span number does not reach the total number of spans (step S2011: No), the integrated control unit 810 increments the span number (step S2012) and returns to the processing in step S2005. On the other hand, if the span number has reached the total number of spans (step S2011: Yes), the procedure proceeds to processing in step S2013.

In processing in and subsequent to step S2013 illustrated in FIG. 20B, optimization control of pumping power based on an error rate of a reception signal is performed. First, the integrated control unit 810 measures error rate characteristics of the reception signal by the error rate measurement unit 1505 (step S2013).

Then, the integrated control unit 810 determines whether or not the error rate characteristics are within a predetermined allowable range (step S2014). If the error rate characteristics are not within the predetermined allowable range (step S2014: No), the integrated control unit 810 proceeds to processing in and subsequent to step S2015. On the other hand, if the error rate characteristics are within the predetermined allowable range (step S2014: Yes), the integrated control unit 810 ends the above processing.

In step S2015, the integrated control unit 810 initializes the span number (step S2015), and then, the integrated control unit 810 determines whether or not the span includes the forward pumping Raman (step S2016). In a case where the span includes the forward pumping Raman (step S2016: Yes), the integrated control unit 810 proceeds to processing in step S2017, and in a case where the span does not include the forward pumping Raman (step S2016: No), the integrated control unit 810 proceeds to processing in step S2022.

In step S2017, the integrated control unit 810 determines whether or not the table number is less than the maximum table number (step S2017). For the transmission-side pumping light power ratio table 1800 and the reception-side pumping light power ratio table 1900, the plurality of table numbers is prepared for the number of different forward pumping and backward pumping powers in order to vary the pumping light power. In the following control, for example, the integrated control unit 810 performs control for lowering the pumping power, each time when the table number is incremented within the allowable range of the error rate.

If the current table number is not less than the maximum table number (step S2017: No), the integrated control unit 810 proceeds to processing in step S2022. On the other hand, if the table number is less than the maximum table number (step S2017: Yes), the integrated control unit 810 proceeds to processing in step S2018.

In step S2018, the integrated control unit 810 increments the table number in order to change the span pumping ratio table (step S2018). Then, the integrated control unit 810 measures the error rate characteristics again (step S2019) and determines whether or not the error rate is improved (step S2020). If the error rate is improved (step S2020: Yes), the integrated control unit 810 proceeds to processing in step S2021. On the other hand, if the error rate is not improved (step S2020: No), the integrated control unit 810 returns to the processing in step S2017.

In step S2021, the integrated control unit 810 decrements the table number in order to change the span pumping ratio table (step S2021). Next, the integrated control unit 810 determines whether or not the span number reaches the total number of spans (step S2022). If the span number does not reach the total number of spans (step S2022: No), the integrated control unit 810 increments the span number (step S2023) and returns to the processing in step S2016. On the other hand, if the span number has reached the total number of spans (step S2022: Yes), the above processing ends.

According to the configuration example 3, the pumping light that causes the XPM deterioration is extracted through measurement for each span, and the span loss and the power wavelength characteristics at the time of the predetermined pumping control are determined by measuring the forward pumping and backward pumping powers. In addition, the control for varying the pumping light power in correspondence with the table number is performed based on the error rate of the reception signal. As a result, it is possible to cope with the transmission characteristics different for each span, avoid the effect of the XPM in a case where the optical transmission line is the DSF 120, improve the error rate of the reception signal, and prevent the deterioration in the signal quality.

### Pumping Control Example for Another Dispersion Shifted Fiber

In the embodiment described above, the pumping control for the DSF has been described. In the following description, pumping control for suppressing XPM deterioration on a TWRS and an ELEAF that are NZ-DSF will be described. The TWRS is an abbreviation of a true wave reduced slope (RS), and the ELEAF is an abbreviation of an enhanced large effective area fiber.

### Wavelength Dispersion Characteristics of TWRS And ELEAF

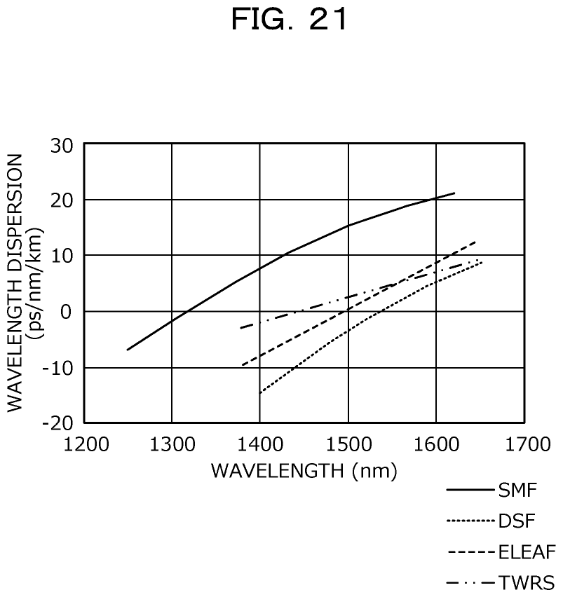

FIG. 21 is a table illustrating wavelength dispersion characteristics of the TWRS and the ELEAF. For reference, in FIG. 21, wavelength dispersion characteristics of an SMF in which dispersion becomes zero near the wavelength of 1310 nm and a DSF in which dispersion becomes zero near the wavelength of 1550 nm are illustrated. The TWRS has the wavelength dispersion characteristics in which the dispersion becomes zero near the wavelength of 1452 nm, and the ELEAF has the wavelength dispersion characteristics in which the dispersion becomes zero near the wavelength of 1499 nm. These NZ-DSFs are widely provided fibers, and the C band and the L band are used as signal bands. Next, problems in a case where the TWRS and the ELEAF are used as the optical transmission line 120 will be described.

### About XPM Deterioration Caused by Forward Pumping of TWRS

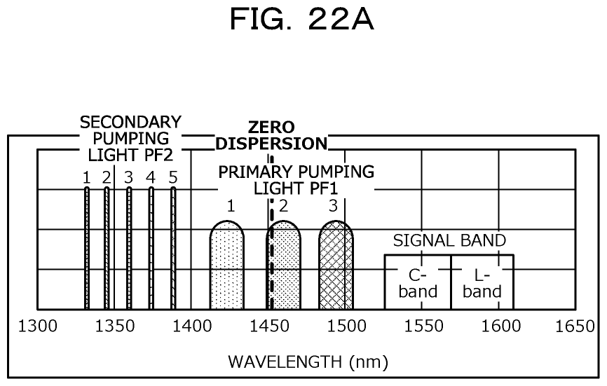

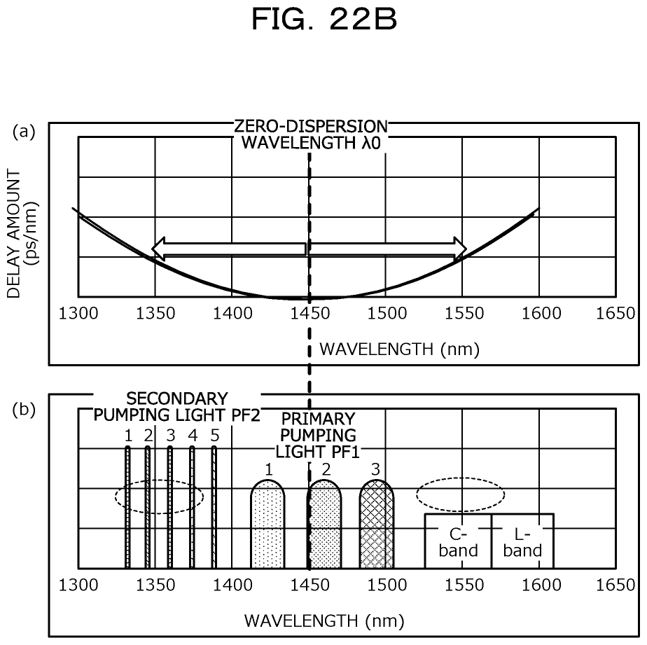

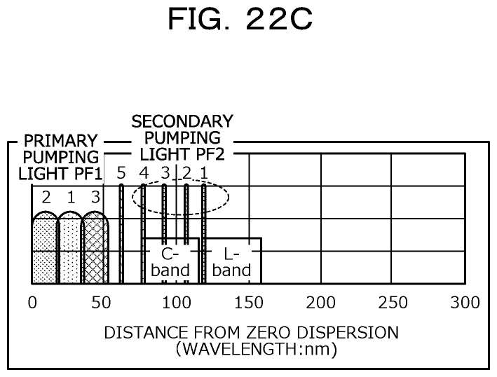

FIGS. 22A to 22C are tables for explaining problems caused by forward pumping Raman amplification for the TWRS. In FIG. 22A, a relationship between a zero-dispersion wavelength in a case of the TWRS, a signal band (C-Band and L-band) of the WDM, and a pumping wavelength is illustrated. The horizontal axis indicates a wavelength, and the vertical axis indicates pumping power. For convenience, numbers 1 to 5 are given to respective wavelengths (λ) from the shorter wavelength side of the secondary pumping light PF2 to the longer wavelength side, and numbers 1 to 3 are given to respective wavelengths (λ) from the shorter wavelength side of the primary pumping light PF1 to the longer wavelength side.

In FIG. 22B, a relationship between the zero-dispersion wavelength in a case of the TWRS, a wavelength (C-band and L-band) of signal light of the WDM, and the pumping wavelength is illustrated. As illustrated in FIG. 22B(a), the TWRS has delay characteristics of a quadratic function having zero dispersion (wavelength 1452 nm) therebetween. This delay characteristics are superimposed on arrangement of the signal band and the pumping light on the wavelength axis as illustrated in FIG. 22B(b). As illustrated in FIG. 22B(b), an almost entire band of the C-band and a part of the band of the L-band have the same delay amount as the wavelengths 1 to 4 of the secondary pumping light PF2 and are transmitted through a fiber at the same speed. Since the XPM caused in the fiber of the TWRS strongly occurs between light beams that are transmitted at the same speed, the signal light is largely affected by the XPM from the secondary pumping light PF2.

In FIG. 22C, for easy understanding of a distance of a signal and pumping light from zero dispersion, FIG. 22B(b) is rearranged as the distance from the zero dispersion. The horizontal axis indicates a distance (wavelength) from the zero-dispersion wavelength, and the left end of the horizontal axis is set to zero.

As illustrated in FIG. 22C, a signal with each wavelength in FIG. 22B(b) is folded at the zero-dispersion wavelength λ0. In the example in FIG. 22C, it is illustrated that the entire signal band of the C band and the shorter wavelength side of the L band overlap the wavelengths 1 to 4 of the secondary pumping light PF2 and the wavelength causes the XPM.

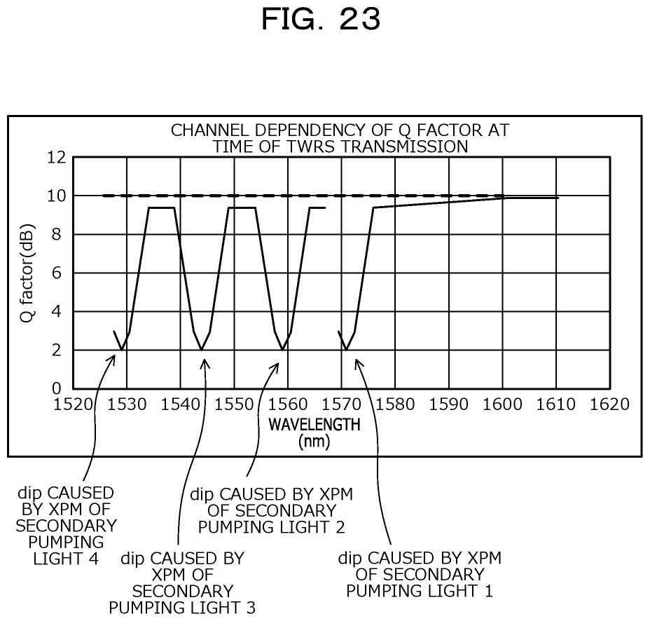

FIG. 23 is a table illustrating deterioration in a Q factor caused by the XPM. FIG. 23 illustrates wavelength characteristics of the Q factor in a case of wavelength arrangement of pumping light illustrated in FIG. 22C. The vertical axis indicates a Q factor, and the horizontal axis indicates a wavelength. As illustrated in FIG. 23, in a signal band with the same delay amount as the secondary pumping light PF2 (wavelengths 1 to 4), dip occurs in the Q factor, and the Q factor is largely deteriorated. Since a power density of the secondary pumping light PF2 is large, there are problems in that the effect of the XPM becomes very large and the signal quality of the signal light S is largely deteriorated.

### About XPM Deterioration Caused by Forward Pumping of ELEAF

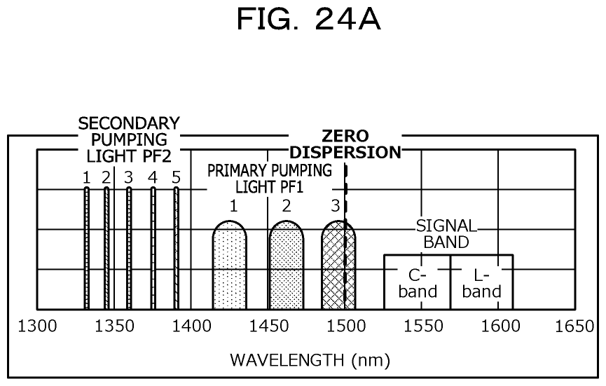

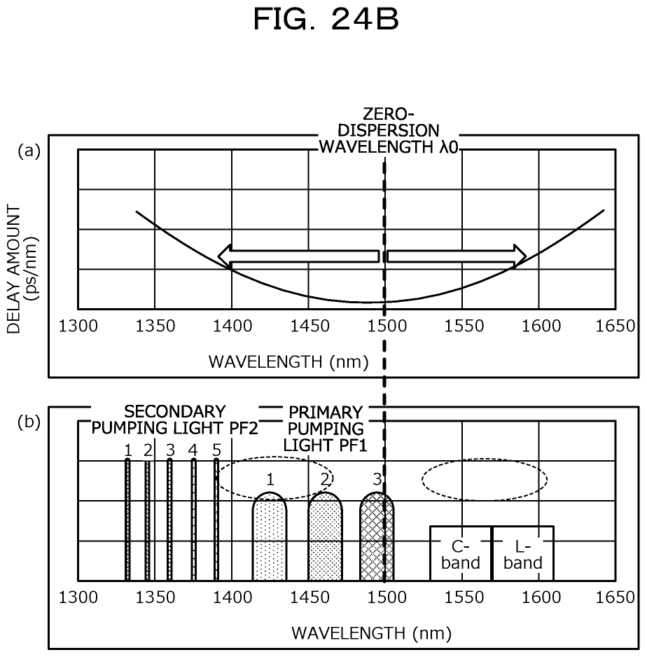

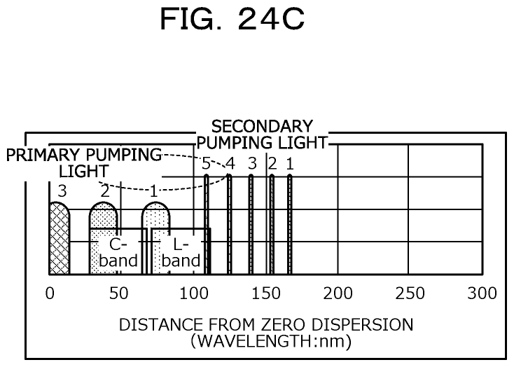

FIGS. 24A to 24C are tables for explaining problems occurring in the forward pumping Raman amplification on the ELEAF. In FIG. 24A, a relationship between a zero-dispersion wavelength in a case of the ELEAF, a signal band (C-Band and L-band) of the WDM, and a pumping wavelength is illustrated. The horizontal axis indicates a wavelength, and the vertical axis indicates pumping power. For convenience, numbers 1 to 5 are given to respective wavelengths (λ) from the shorter wavelength side of the secondary pumping light PF2 to the longer wavelength side, and numbers 1 to 3 are given to respective wavelengths (λ) from the shorter wavelength side of the primary pumping light PF1 to the longer wavelength side.

In FIG. 24B, a relationship between the zero-dispersion wavelength in a case of the ELEAF, the wavelength (C-band and L-band) of the signal light of the WDM, and the pumping wavelength is illustrated. As illustrated in FIG. 24B(a), the TWRS has delay characteristics of a quadratic function having zero dispersion (wavelength 1499 nm) therebetween. This delay characteristics are superimposed on arrangement of the signal band and the pumping light on the wavelength axis as illustrated in FIG. 24B(b). As illustrated in FIG. 24B(b), a part of the band of the C-band and a part of the band of the L-band have the same delay amount as the wavelength 5 of the primary pumping light 1 and 2 and the secondary pumping light PF2 and are transmitted through a fiber at the same speed. Since the XPM caused in the fiber of the TWRS strongly occurs between light beams that are transmitted at the same speed, the signal light is largely affected by the XPM from the primary pumping light PF1 and the secondary pumping light PF2.

In FIG. 24C, for easy understanding of a distance of a signal and pumping light from the zero dispersion, FIG. 24B(b) is rearranged as the distance from the zero dispersion. The horizontal axis indicates a distance (wavelength) from the zero-dispersion wavelength, and the left end of the horizontal axis is set to zero.

As illustrated in FIG. 24C, a signal with each wavelength in FIG. 24B(b) is folded at the zero-dispersion wavelength λ0. In the example in FIG. 24C, the longer wavelength side of the C band overlaps the wavelength 2 of the primary pumping light PF1, and the shorter wavelength side of the C band overlaps the wavelength 1 of the primary pumping light PF1. Furthermore, it is illustrated that the longer wavelength side of the L band overlaps the wavelength 1 of the primary pumping light, the shorter wavelength side of the L band overlaps the wavelength 5 of the secondary pumping light, and the wavelength causes the XPM.

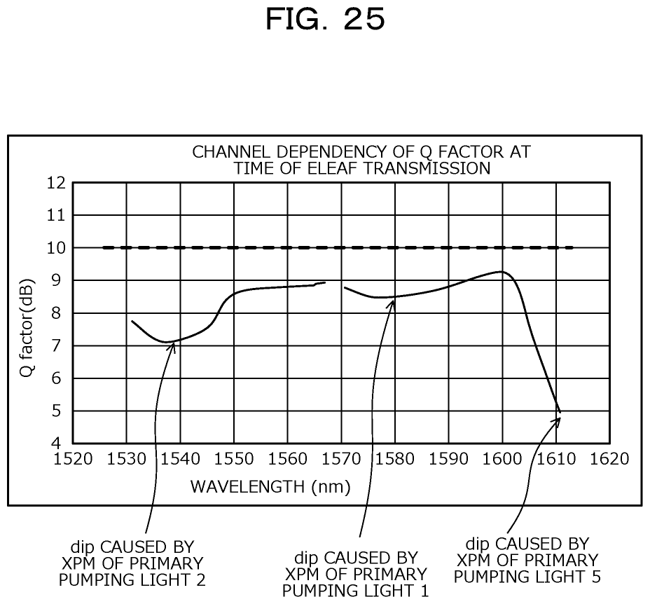

FIG. 25 is a table illustrating deterioration in the Q factor caused by the XPM. FIG. 25 illustrates wavelength characteristics of the Q factor in a case of wavelength arrangement of pumping light illustrated in FIG. 24C. The vertical axis indicates a Q factor, and the horizontal axis indicates a wavelength. As illustrated in FIG. 25, in a signal band having the same delay amount as the wavelengths 1 and 2 of the primary pumping light PF1 and the wavelength 5 of the secondary pumping light PF2, dip is caused in the Q factor, and the Q factor is largely deteriorated. For example, since a power density of the secondary pumping light PF2 is larger than the primary pumping light, there are problems in that the effect of the XPM becomes very large and the signal quality of the signal light S is largely deteriorated.

As described above, in the TWRS and the ELEAF that are NZ-DSF, the signal quality of the signal light S is deteriorated by the pumping light that causes the XPM. For example, the power density of the secondary pumping light is larger than the primary pumping light, the signal quality is largely deteriorated. Therefore, in the embodiment, by quenching the pumping light that causes the XPM or reducing optical power, the deterioration is not caused. Furthermore, the forward pumping Raman gain is secured to some extent, and this makes it possible to expect to improve the transmission characteristics by the forward pumping Raman.

For example, in the embodiment, in a case where the forward pumping secondary pumping light PF2 causes the XPM, a deterioration amount is very large. Therefore, light having the corresponding wavelength is quenched. Furthermore, in a case where the primary pumping light PF1 causes the XPM, in a case of one beam of the pumping light having the wavelength, the pumping light is quenched, and in a case of the plurality of beams of pumping light, the pumping light having the wavelength closer to the zero dispersion is quenched, and power of the pumping light having the wavelength away from the zero dispersion is reduced to be equal to or less than a predetermined amount, for example, 50%.

Although an appropriate power reduction amount for forward pumping can be obtained through calculation in advance, the appropriate power reduction amount may be predicted based on actual measurement data. Then, reduction in a gain caused by reducing the pumping power of the forward pumping is compensated by adjusting a gain between the forward pumping light sources and adjusting gain wavelength characteristics of the backward Raman. For example, the adjustment of the gain between the forward pumping light sources includes to compensate shortage of the gain caused by quenching the secondary pumping light PF2 with increase of the power of the corresponding primary pumping light PF1.

### Pumping Control Example for TWRS

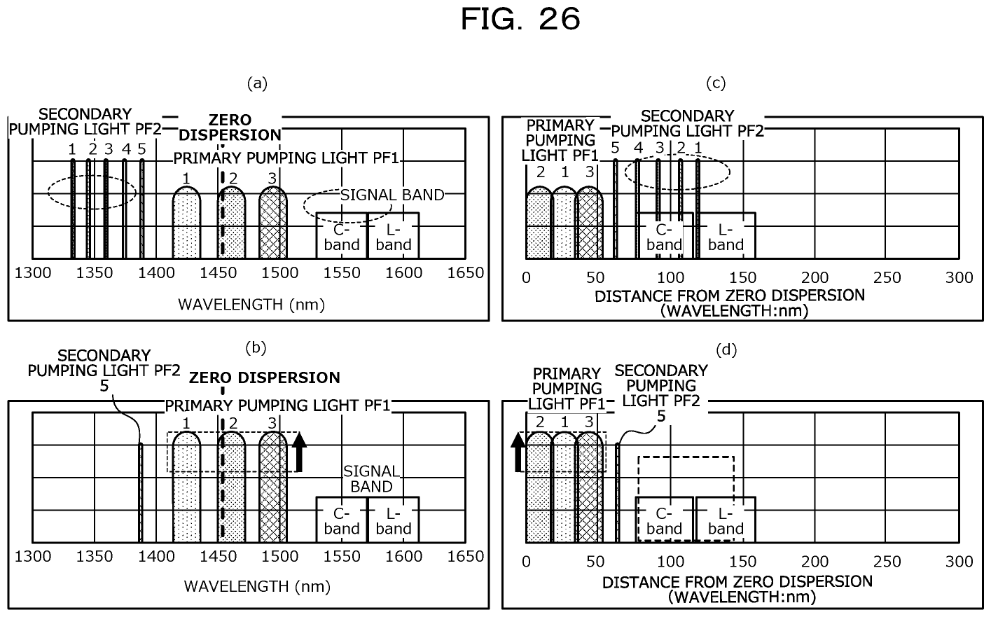

FIG. 26 is an explanatory diagram illustrating a pumping control example for the TWRS. The horizontal axis indicates a wavelength, and the vertical axis indicates optical power. FIG. 26(a) is a table illustrating a relationship between pumping light and a signal band before XPM countermeasure is taken, and FIG. 26(b) is a table illustrating a relationship between pumping light and a signal band after the XPM countermeasure is taken.

As illustrated in FIG. 26(a), in the TWRS, the wavelengths 1 to 4 of the secondary pumping light PF2 cause the signal band (entire band of C band and a part of band of L band) XPM. Therefore, as illustrated in FIG. 26(b), the optical transmission device 110 performs quenching control on the wavelengths 1 to 4 of the secondary pumping light PF2 and suppresses signal deterioration. Furthermore, in order to compensate the decrease in the Raman gain caused by quenching the wavelengths 1 to 4 of the secondary pumping light PF2, the optical transmission device 110 performs control for increasing the power of the primary pumping light PF1 (wavelengths 1 to 3).

Note that FIGS. 26(c) and 26(d) are diagrams in which the signal bands of the signal light S respectively illustrated in FIGS. 26(a) and 26(b) and the pumping light are rearranged at distances from the zero-dispersion wavelength on the wavelength axis. The horizontal axis indicates a distance (wavelength) from the zero-dispersion wavelength, and the vertical axis indicates optical power. FIG. 26(c) illustrates a relationship between pumping light and a signal band before the XPM countermeasure is taken, and FIG. 26(d) is a table illustrating a relationship between the pumping light and the signal band after the XPM countermeasure is taken.

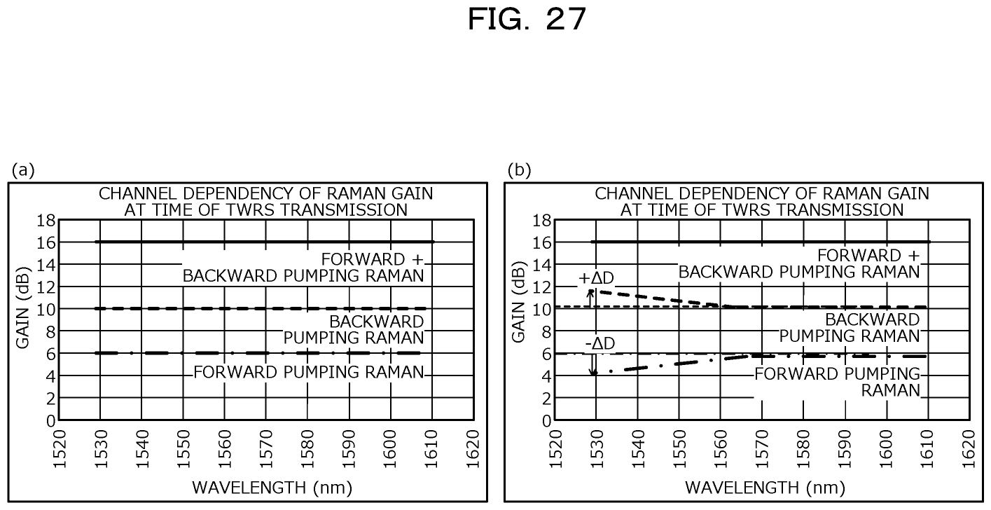

FIG. 27 is a table illustrating Raman gains before and after the XPM countermeasure. The horizontal axis indicates a wavelength, and the vertical axis indicates a gain. FIG. 27(a) illustrates channel dependency of the Raman gain before the XPM countermeasure, and FIG. 27(b) illustrates channel dependency of the Raman gain after the XPM countermeasure.

It is illustrated that, before the XPM countermeasure illustrated in FIG. 27(a), in TWRS transmission, in any one of only forward pumping, only backward pumping, and the forward pumping and the backward pumping, a gain of the entire wavelength band is flat, and the channel dependency of the Raman gain does not occur. In contrast to FIG. 27(a), wavelength dependency of the Raman gain changes after the XPM countermeasure illustrated in FIG. 27(b).

As illustrated in FIG. 27(b), since the shortage of the gain is caused due to the quenching of the secondary pumping light PF2, the optical transmission device 110 according to the embodiment increases the power of the primary pumping light PF1 and compensates the gain. Here, as compared with a case of the secondary pumping light PF2 illustrated in FIG. 27(a), in FIG. 27(b), the gain gradually becomes insufficient (−ΔD) as the wavelength becomes shorter, and the gain on the longer wavelength side is slightly insufficient. Therefore, the gain is compensated (+ΔD) with a backward Raman PB corresponding to the insufficient amount (−ΔD). As a result, flatness of the Raman gain (solid line in FIG. 27) due to the pumping control (forward pumping and backward pumping) after the XPM countermeasure can be secured.

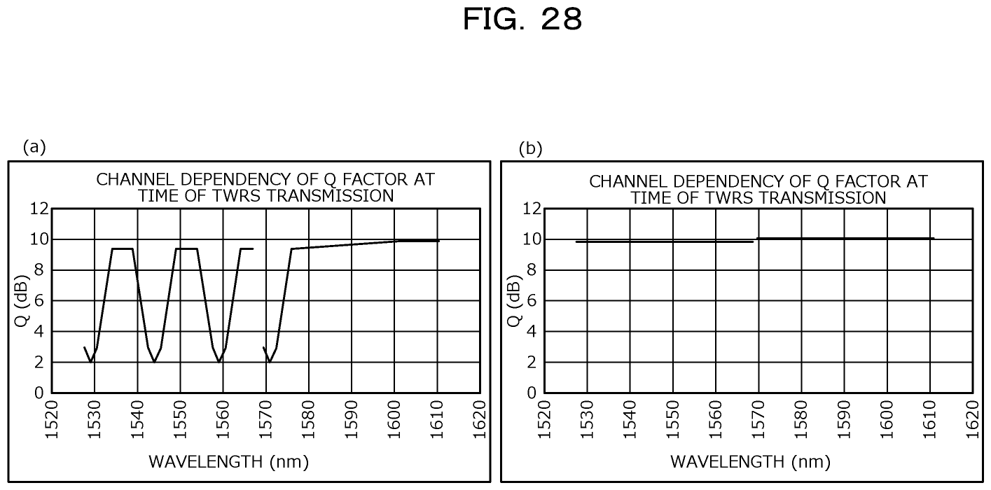

FIG. 28 is a table illustrating Q factors before and after the XPM countermeasure. The horizontal axis indicates a wavelength, and the vertical axis indicates a Q factor. FIG. 28(a) illustrates wavelength dependency of the Q factor before the XPM countermeasure, and FIG. 28(b) illustrates wavelength dependency of the Q factor after the XPM countermeasure.

Before the XPM countermeasure illustrated in FIG. 28(a), in the TWRS transmission, in a signal band having the same delay amount as the secondary pumping light PF2 (wavelengths 1 to 4), dip occurs in the Q factor, and the Q factor is largely deteriorated. On the other hand, as illustrated in FIG. 28(b), the optical transmission device 110 according to the embodiment can suppress large deterioration in the Q factor.

### Pumping Control Example for ELEAF

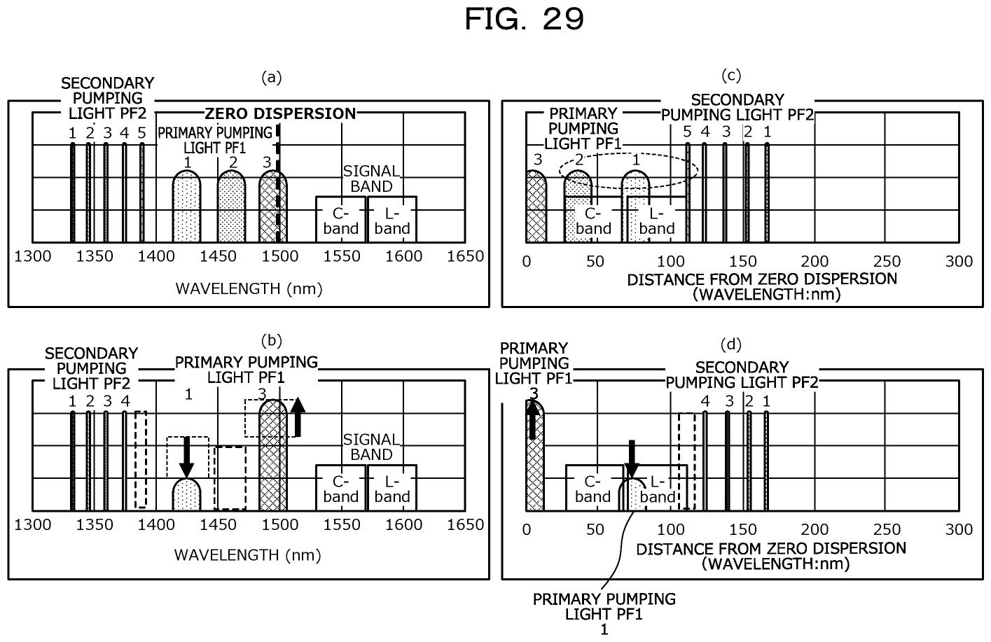

FIG. 29 is an explanatory diagram illustrating a pumping control example for the ELEAF. The horizontal axis indicates a wavelength, and the vertical axis indicates optical power. FIG. 29(a) is a table illustrating a relationship between pumping light and a signal band before XPM countermeasure is taken, and FIG. 29(b) is a table illustrating a relationship between pumping light and a signal band after the XPM countermeasure is taken.

As illustrated in FIG. 29(a), in the ELEAF, the wavelengths 1 and 2 of the primary pumping light PF1 and the wavelength 5 of the secondary pumping light PF2 cause the XPM in the signal band of the C band and the L band. Therefore, as illustrated in FIG. 29(b), the optical transmission device 110 performs quenching control on the wavelength 5 of the secondary pumping light PF2. Furthermore, the optical transmission device 110 quenches the wavelength 2 of the primary pumping light PF1 close to the zero dispersion, of the primary pumping light PF1 and performs control for lowering the power of the wavelength 1 of the primary pumping light PF1 to be equal to or less than a predetermined amount, for example, 50%. Furthermore, in order to compensate the decrease in the Raman gain caused by quenching the wavelength 5 of the secondary pumping light PF2, the optical transmission device 110 performs control for increasing the power of the wavelength 3 of the primary pumping light PF1.

Note that FIGS. 29(c) and 29(d) are diagrams in which the signal bands of the signal light S respectively illustrated in FIGS. 29(a) and 29(b) and the pumping light are rearranged at distances from the zero-dispersion wavelength on the wavelength axis. The horizontal axis indicates a distance (wavelength) from the zero-dispersion wavelength, and the vertical axis indicates optical power. FIG. 29(c) illustrates a relationship between pumping light and a signal band before the XPM countermeasure is taken, and FIG. 29(d) is a table illustrating a relationship between the pumping light and the signal band after the XPM countermeasure is taken.

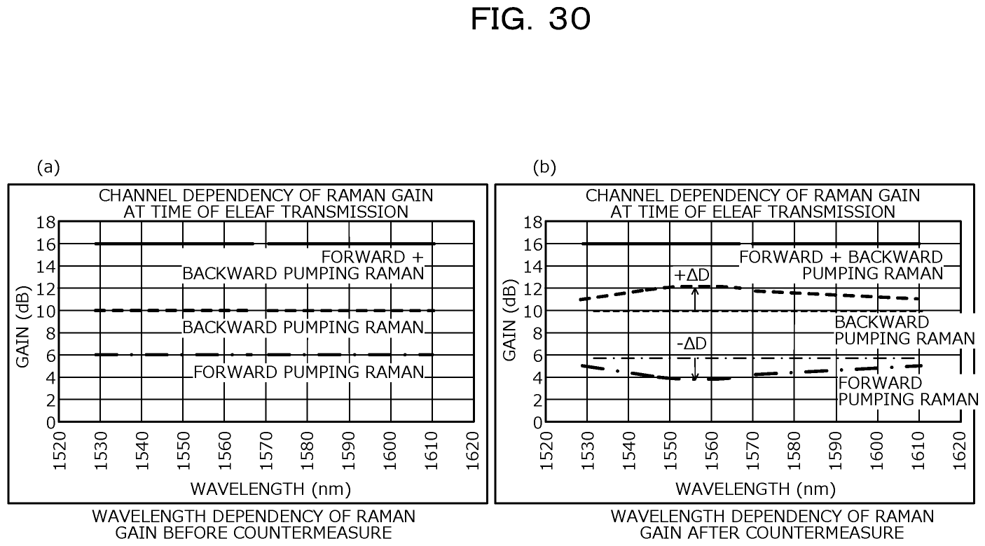

FIG. 30 is a table illustrating Raman gains before and after the XPM countermeasure. The horizontal axis indicates a wavelength, and the vertical axis indicates a gain. FIG. 30(a) illustrates channel dependency of the Raman gain before the XPM countermeasure, and FIG. 30(b) illustrates channel dependency of the Raman gain after the XPM countermeasure.

It is illustrated that, before the XPM countermeasure illustrated in FIG. 30(a), in ELEAF transmission, in any one of only forward pumping, only backward pumping, and the forward pumping and the backward pumping, a gain of the entire wavelength band is flat, and the channel dependency of the Raman gain does not occur. In contrast to FIG. 30(a), wavelength dependency of the Raman gain changes after the XPM countermeasure illustrated in FIG. 30(b).

As illustrated in FIG. 30(b), the optical transmission device 110 according to the embodiment compensates (+ΔD) the gain with the backward Raman PB in response to the insufficient amount (−ΔD) of the gain in a central portion of the signal band caused by quenching the wavelength 2 of the secondary pumping light PF2. As a result, flatness of the Raman gain (solid line in FIG. 27) due to the pumping control (forward pumping and backward pumping) after the XPM countermeasure can be secured.

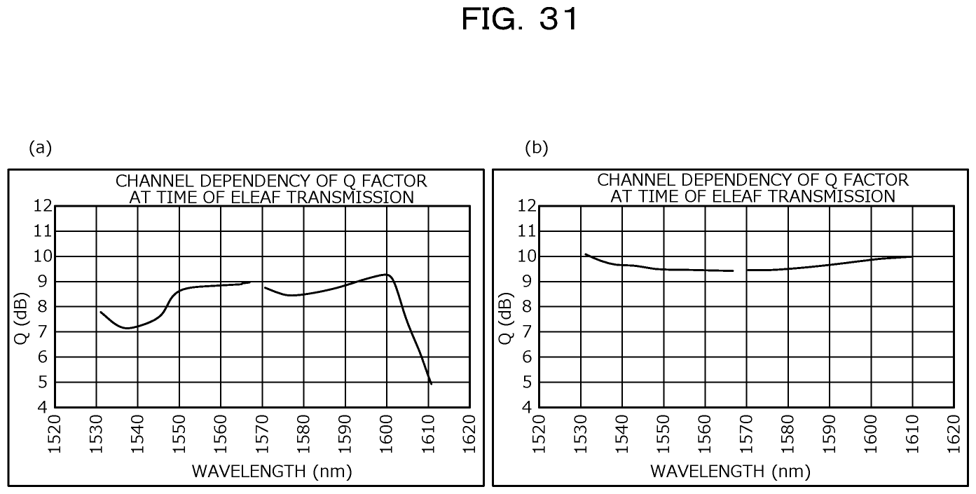

FIG. 31 is a table illustrating Q factors before and after the XPM countermeasure. The horizontal axis indicates a wavelength, and the vertical axis indicates a Q factor. FIG. 31(a) illustrates wavelength dependency of the Q factor before the XPM countermeasure, and FIG. 31(b) illustrates wavelength dependency of the Q factor after the XPM countermeasure.

Before the XPM countermeasure illustrated in FIG. 31(a), in the ELEAF transmission, in a signal band having the delay amount same as the wavelengths 1 and 2 of the primary pumping light PF1 and the wavelength 5 of the secondary pumping light PF2, dip occurs in the Q factor, and the Q factor is largely deteriorated. On the other hand, as illustrated in FIG. 31(b), the optical transmission device 110 according to the embodiment can suppress the large deterioration in the Q factor, although the Q factor is slightly deteriorated due to the effect of the shortage of the gain of the forward pumping Raman in the central portion of the signal band.

### Pumping Control Example Compatible with Various Fibers

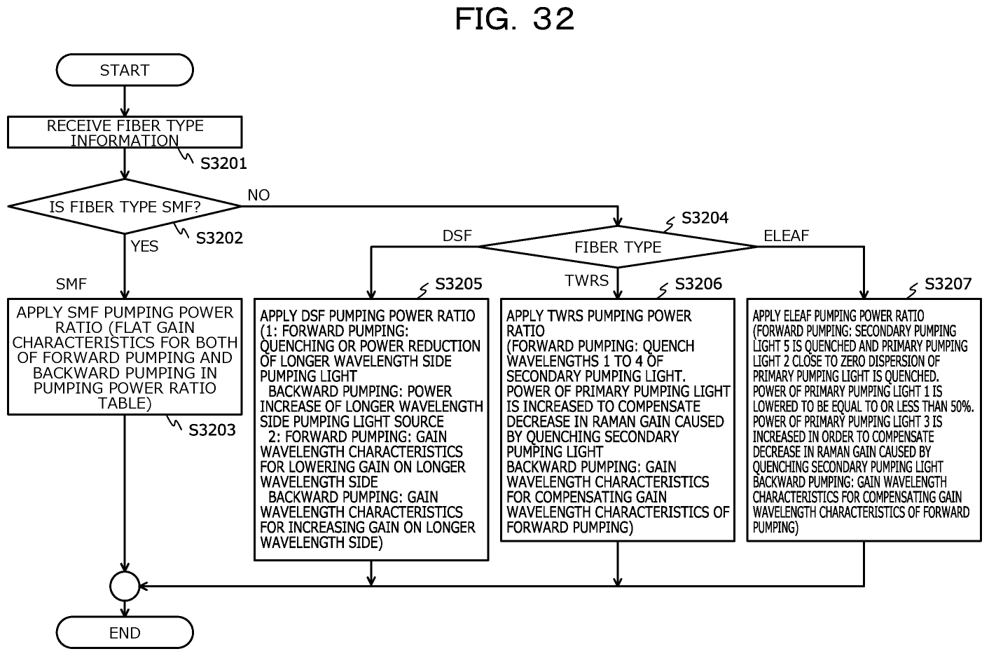

FIG. 32 is a flowchart illustrating a pumping light control example compatible with various fibers according to the embodiment. FIG. 32 illustrates a control example (refer to FIG. 1F) for the DSF described above. In the embodiment, the pumping control is changed according to the fiber types including the DSF, the TWRS, and the ELEAF.

Processing in FIG. 32 can be executed by the forward pumping control unit 150A of the first optical transmission device 110A and the backward pumping control unit 150B of the second optical transmission device 110B in cooperation in the bidirectional pumping control system 100 described with reference to FIG. 1F (control example 5).

First, each of the forward pumping control unit 150A and the backward pumping control unit 150B receives fiber type information (step S3201). The fiber type information may be manually input by a person in charge maintenance or the like or may be input from a management server or the like via a network.

Next, each of the forward pumping control unit 150A and the backward pumping control unit 150B determines the input fiber type (step S3202). Here, it is determined whether or not the fiber type of the optical transmission line 120 is the SMF.

In a case where the input fiber type is the SMF (step S3202: Yes), the forward pumping control unit 150A performs forward pumping to which the pumping power ratio for the SMF is applied (step S3203). Similarly, the backward pumping control unit 150B performs forward pumping to which the pumping power ratio for the SMF is applied. For example, in control of the forward pumping of the forward pumping control unit 150A and the backward pumping of the backward pumping control unit 150B, the pumping power ratio for the SMF that has been formed as a table in advance is used. The pumping power ratio table for the SMF has gain characteristics flat with respect to the wavelength, together with the forward pumping and the backward pumping (for example, refer to FIG. 1E(b)).

On the other hand, the input fiber type is other than the SMF (step S3202: No), each of the forward pumping control unit 150A and the backward pumping control unit 150B determines the input fiber type (step S3204).

In step S3024, in a case where the input fiber type is the DSF (step S3204: DSF), the forward pumping control unit 150A and the backward pumping control unit 150B perform forward pumping to which the pumping power ratio for the DSF is applied (step S3205). Processing in step S3205 is the same as the processing in step S104 in FIG. 1F. For example, in control of the forward pumping of the forward pumping control unit 150A and backward pumping of the backward pumping control unit 150B, pumping is controlled with reference to the pumping power ratio for the DSF that has been formed as a table in advance.

For example, 1. in the pumping power ratio table for the DSF, quenching of a longer wavelength side pumping light source for the forward pumping (corresponding to control example 1), power reduction (corresponding to control example 2) is set, and the forward pumping control unit 150A refers to the pumping power ratio table and controls the forward pumping. Correspondingly, about the backward pumping, a power increase of the pumping light source on the longer wavelength side is set to the pumping power ratio table for the DSF, and the backward pumping control unit 150B controls the backward pumping with reference to the pumping power ratio table.

In addition, 2. in the pumping power ratio table for the DSF, gain wavelength characteristics in which a gain is lowered on the longer wavelength side is set for the forward pumping, and the forward pumping control unit 150A controls the forward pumping with reference to the pumping power ratio table. Correspondingly, about the backward pumping, gain wavelength characteristics in which a gain increases on the longer wavelength side are set to the pumping power ratio table for the DSF, and the backward pumping control unit 150B controls the backward pumping with reference to the pumping power ratio table (control example 5 (refer to FIG. 1E(c))).

Furthermore, in step S3024, in a case where the input fiber type is the TWRS (step S3204: TWRS), the forward pumping control unit 150A and the backward pumping control unit 150B perform forward pumping to which a pumping power ratio for the TWRS is applied (step S3206).

For example, the forward pumping control unit 150A performs quenching control on the wavelengths 1 to 4 of the secondary pumping light PF2. Furthermore, the forward pumping control unit 150A performs control for increasing the power of the primary pumping light PF1, in order to compensate the decrease in the Raman gain caused by quenching the secondary pumping light PF2 (refer to FIG. 26). Furthermore, the backward pumping control unit 150B performs control for compensating the gain with the backward pumping PB, based on the gain wavelength characteristics (refer to FIG. 27) for compensating the gain wavelength characteristics of the forward pumping.

Furthermore, in step S3024, in a case where the input fiber type is the ELEAF (step S3204: ELEAF), the forward pumping control unit 150A and the backward pumping control unit 150B performs forward pumping to which a pumping power ratio for the ELEAF is applied (step S3207).

For example, the forward pumping control unit 150A performs quenching control on the wavelength 5 of the secondary pumping light PF2. Furthermore, the forward pumping control unit 150A performs quenching control on the wavelength 2 of the primary pumping light PF1 close to the zero dispersion, of the primary pumping light PF1 and performs control for lowering the power of the wavelength 1 of the primary pumping light PF1 to be equal to or less than a predetermined amount, for example, 50%. Furthermore, the forward pumping control unit 150A performs control for increasing the power of the wavelength 3 of the primary pumping light PF1, in order to compensate the decrease in the Raman gain caused by quenching the secondary pumping light PF2 (refer to FIG. 29). Furthermore, the backward pumping control unit 150B performs control for compensating the gain with the backward pumping PB, based on the gain wavelength characteristics (refer to FIG. 30) for compensating the gain wavelength characteristics of the forward pumping.

The forward pumping control unit 150A and the backward pumping control unit 150B end bidirectional pumping control compatible with the fiber type through the control in step S3203 or steps S3205 to S3207. The forward pumping control unit 150A and the backward pumping control unit 150B continuously perform pumping control based on bidirectional pumping power of which setting has been changed, during the operation of the optical transmission line 120.

The pumping light wavelength that causes the XPM depends on the zero-dispersion wavelength, the NZ-DSF has the zero-dispersion wavelength that differs depending on the fiber type and different pumping light that causes the XPM. Fibers of which manufacturing periods are close are provided in an actual optical transmission system, and the zero-dispersion wavelength can be substantially specified from the fiber type information. Therefore, it is possible to avoid the deterioration caused by the XPM through the processing illustrated in FIG. 32.

### Pumping Control Example Corresponding to Variation of Zero-Dispersion Wavelength

On the other hand, there is a possibility that zero-dispersion wavelengths of fibers of which manufacturing periods vary or fibers manufactured at an initial stage vary. In the following description, a pumping control example will be described for specifying a pumping light wavelength that causes the XPM with the fibers of which the zero-dispersion wavelengths vary and avoiding the deterioration caused by the XPM.

The pumping light wavelength that causes the XPM depends on the zero-dispersion wavelength, and there is a possibility that zero-dispersion wavelengths of transmission line fibers vary. In the embodiment described below, by performing pumping light control as in the above after specifying the pumping light wavelength that causes the XPM, the deterioration caused by the XPM is avoided.

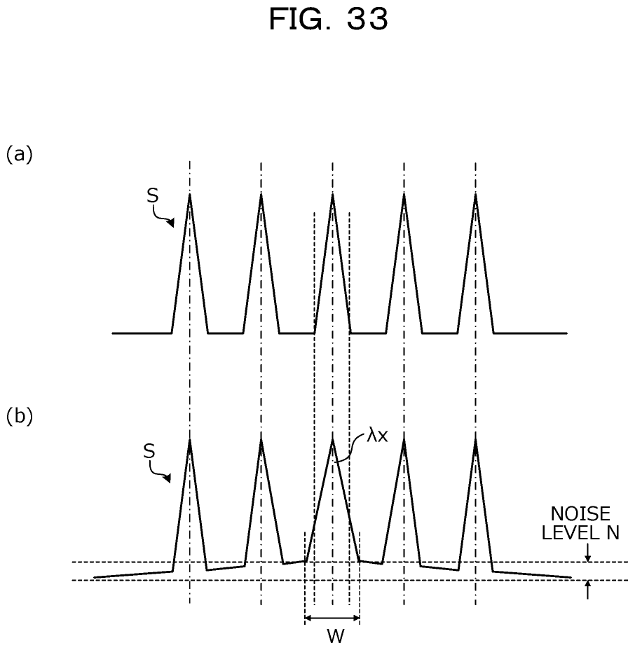

FIG. 33 is a waveform diagram illustrating spectra before and after XPM occurrence. The horizontal axis indicates a wavelength, and the vertical axis indicates optical power. FIG. 33(a) is a waveform diagram of the signal light S before receiving the XPM, and FIG. 33(b) is a waveform diagram of the signal light S after receiving the XPM. In a case where the XPM to the signal light S caused by the pumping light occurs, as illustrated in FIG. 33(b), the signal quality (Q factor) of the signal light S is deteriorated, and at the same time, a noise level N is also deteriorated. For example, at a wavelength λx of the signal light S receiving the XPM, a bandwidth (signal spectrum) W is widened, the noise level N increases, and the OSNR is deteriorated.

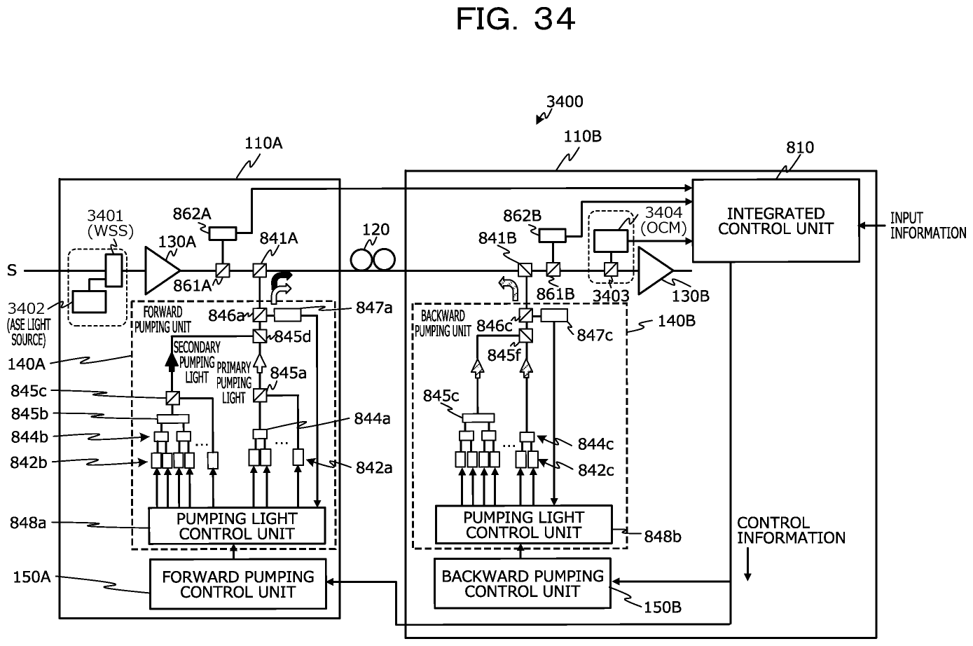

FIG. 34 is a diagram illustrating a configuration example of an optical transmission system that performs XPM countermeasure with an OSNR monitor. In an optical transmission system 3400 illustrated in FIG. 34, a component same as the component described above (refer to FIG. 8) is denoted with the same reference numeral, and description thereof will be omitted.

For example, as described with reference to FIG. 8, the optical transmission system 3400 includes the first optical transmission device 110A that performs forward pumping on the signal light S and the second optical transmission device 110B that performs backward pumping. Furthermore, an integrated control unit 81 is arranged in the second optical transmission device 110B.

In FIG. 34, a difference from the configuration in FIG. 8 is that, in the first optical transmission device 110A, a WSS 3401 and an amplified spontaneous emission (ASE) light source 3402 are arranged at an input stage of the signal light S, and output of the WSS 3401 is input to the optical amplifier 130A. Furthermore, on the second optical transmission device 110B side, a demultiplexer 3403 is arranged at an output stage of an optical signal (preceding stage of optical amplifier 130B), and an optical signal S is detected by an OCM 3404 via the demultiplexer 3403. A DGEQ may be arranged instead of the WSS 3401.

The WSS 3401, the ASE light source 3402, and the OCM 3404 are coupled to the integrated control unit 810. For example, the integrated control unit 810 controls the WSS 3401 and the ASE light source 3402 on the first optical transmission device 110A side at the time of non-operation (non-transmission) of the optical signal S, and generates and transmits comb-shaped dummy light (waveform corresponding to FIG. 33(a)) with the WSS 3401 using ASE light.

Then, the integrated control unit 810 measures an OSNR when the dummy light is received by the OCM 3404 on the second optical transmission device 110B side. The integrated control unit 810 can acquire a waveform corresponding to FIG. 33(b), with a monitor of the OSNR. In a case where one beam of forward Raman pumping light is emitted, a spectrum change as in FIG. 33(b) occurs, and deterioration in the OSNR is observed, it is found that the XPM is caused by the pumping light. By performing pumping light control for the forward pumping by the first optical transmission device 110A and the backward pumping by the second optical transmission device 110B, the XPM deterioration is eliminated.

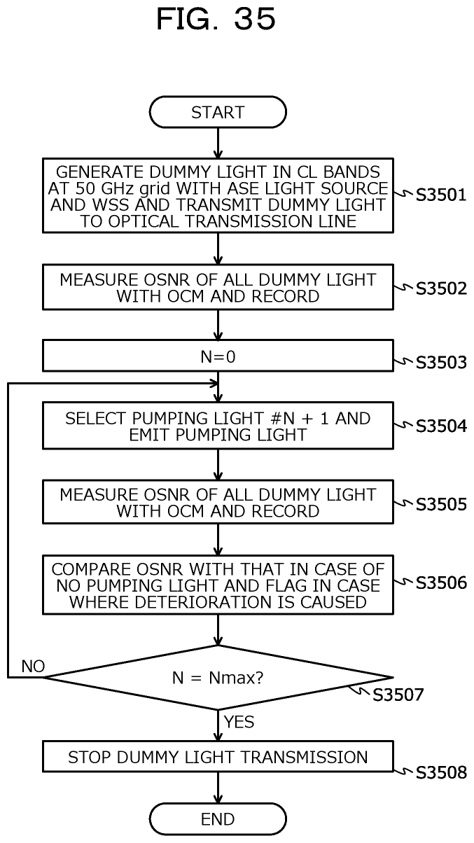

FIG. 35 is a flowchart of a processing example for detecting a wavelength of XPM deterioration with the OSNR monitor. Processing illustrated in FIG. 35 has processing content of a control unit of the integrated control unit 810, and the integrated control unit 810 performs control on each unit of the first optical transmission device 110A and the second optical transmission device 110B, for example, at the time of non-operation of the signal light S.

Note that, for easy description, in FIG. 35, for the forward pumping, wavelengths (numbers) of the secondary pumping light PF2 are set as 1 to 5, wavelengths (numbers) of the primary pumping light PF1 are set to 6 to 8, and pumping light is described as #N (N=1, 2, 3, . . . , 8, Nmax=8).

First, the integrated control unit 810 controls the ASE light source 3402 and the WSS 3401 and, for example, generates dummy light in a C band and an L band and at 50 GHz grid, and transmits the dummy light to an optical transmission line (step S3501). Next, the integrated control unit 810 records a result of measuring an OSNR of all dummy light with the OCM 3403 (step S3502).

Next, the integrated control unit 810 sets the number of detected wavelengths N to an initial value zero (step S3503). Then, the integrated control unit 810 selects forward pumped pumping light #N+1 of the first optical transmission device 110A and emits the pumping light (step S3504).

Next, the integrated control unit 810 records a result of measuring the OSNR of all dummy light with the OCM 3404 (step S3505). Next, the integrated control unit 810 compares the OSNR in a case of no pumping light and the OSNR that is the result in step S3503 and flags a wavelength (number #) of the corresponding pumping light in a case where the deterioration occurs (step S3506).

Then, the integrated control unit 810 determines whether or not N=Nmax (step S3507). If N does not reach Nmax (step S3507: No), the integrated control unit 810 returns to the processing in step S3504. On the other hand, if N reaches Nmax (step S3507: Yes), the integrated control unit 810 stops the transmission of the dummy light by the ASE light source 3402 and the WSS 3401 (step S3508) and ends the above processing.

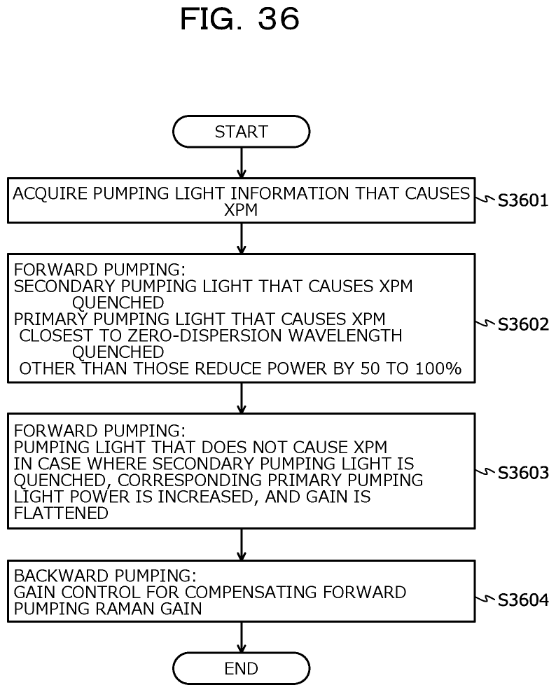

FIG. 36 is a flowchart of a pumping control example for the wavelength of the XPM deterioration. A control example will be described that is performed by the integrated control unit 810 on the forward pumping unit 140A of the first optical transmission device 110A and the backward pumping unit 140B of the second optical transmission device 110B based on information regarding the wavelength that causes the XPM deterioration described with reference to FIG. 35.

First, the integrated control unit 810 acquires the information regarding the wavelength of the pumping light that causes the XPM deterioration detected in FIG. 35 (step S3601). Next, the integrated control unit 810 performs quenching control on the secondary pumping light source 842b of the secondary pumping light PF2 (number #) that causes the XPM, for the forward pumping, based on the information acquired in step S3601. Furthermore, the integrated control unit 810 performs quenching control on the primary pumping light source 842a having the wavelength (number #) closest to the zero dispersion, for the primary pumping light PF1 (number #) that causes the XPM. Furthermore, control is performed for reducing power of the primary pumping light source 842a other than the quenched one by a predetermined amount, for example, 50% to 100% (step S3602).

Next, for the forward pumping, in a case where the integrated control unit 810 quenches the secondary pumping light PF2 (number #) in step S3603, for the pumping light (number #) that does not cause the XPM, the integrated control unit 810 performs control for increasing power of the primary pumping light PF1 (number #) corresponding to the quenched secondary pumping light PF2 (number #) and flattening the gain (step S3603).

Moreover, the integrated control unit 810 controls a gain for the backward pumping unit 140B so as to compensate the gain of the forward pumping Raman performed in step S3603 (step S3604) and ends the above control.

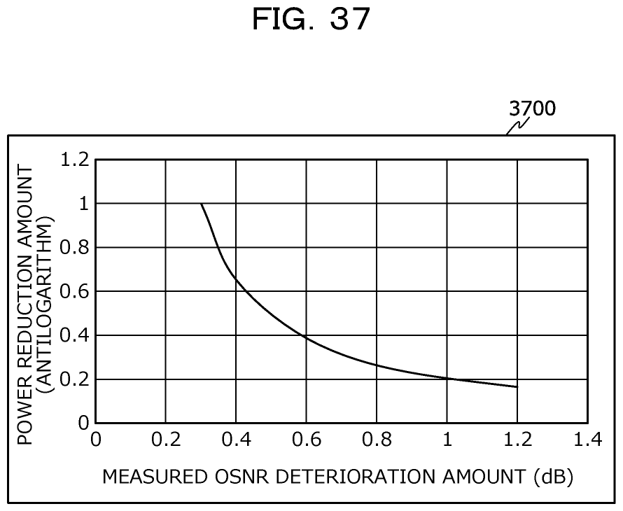

FIG. 37 is a table of an example for explaining determination of a power reduction amount of the primary pumping light that causes the XPM. The horizontal axis in FIG. 37 indicates a power reduction amount of primary pumping light, and the vertical axis indicates an OSNR deterioration amount. Although the pumping light power set to obtain the Raman gain causes OSNR deterioration of 1.2 dB due to the XPM, this OSNR deterioration is eliminated by lowering the pumping light power by 100%.

As described with reference to FIG. 36 or the like, in the embodiment, quenching control is performed on the primary pumping light PF1 that causes the XPM closest to the zero-dispersion wavelength. Furthermore, for the pumping light other than the above, the effect of the XPM is relatively small. Therefore, while suppressing the effect of the XPM, control is performed for reducing power by a predetermined amount, for example, about 50% to 100% in order to secure the Raman gain. A measure of the power reduction is, for example, an OSNR decrease of 0.3 dB caused by the XPM. The power reduction that causes the OSNR decrease of 0.3 dB can be adjusted while monitoring the OSNR. However, the power reduction amount to cause the OSNR decrease to be 0.3 dB can be predicted in advance, based on the measured OSNR deterioration amount.

The relationship of the power reduction amount of the primary pumping light PF1 with respect to the measured OSNR deterioration amount illustrated in FIG. 37 is stored in the memory 1102 or the like of the integrated control unit 810 in advance as a setting table 3700, and then, the integrated control unit 810 refers to the setting table 3700 and determines the power reduction amount of the primary pumping light PF1 corresponding to the measured OSNR deterioration amount.

The forward Raman amplifier according to the embodiment described above that is a forward Raman amplifier having a plurality of pumping light sources with different wavelengths changes the number of pumping light sources to be emitted, according to a fiber type. As a result, in a case where the DSF or the dispersion shifted fiber is used to be compatible with the fiber type used for the optical transmission line, it is possible to reduce the number of pumping light sources by quenching the pumping light source having the wavelength that causes the XPM deterioration or the like, to suppress the XPM deterioration of the signal light, and maintain the signal quality of the signal light. Note that, in a case where the SMF is used for the optical transmission line, the XPM deterioration does not occur. Therefore, the number of pumping light sources to be emitted is not changed.

Furthermore, the forward Raman amplifier according to the embodiment including the plurality of pumping light sources with different wavelengths, in which the forward Raman amplifier changes a power ratio between the plurality of pumping light sources with the different wavelengths, according to the fiber type. As a result, in a case where the DSF and the dispersion shifted fiber are used for the optical transmission line to be compatible with the fiber type used for the optical transmission line, it is possible to suppress the XPM deterioration of the signal light by, for example, lowering the power ratio of the pumping light source with the wavelength that causes the XPM deterioration and to maintain the signal quality of the signal light.

Furthermore, the forward Raman amplifier according to the embodiment including the plurality of pumping light sources with different wavelengths, in which the forward Raman amplifier changes wavelength characteristics of a gain, according to the fiber type. As a result, in a case where the DSF and the dispersion shifted fiber are used for the optical transmission line to be compatible with the fiber type used for the optical transmission line, it is possible to suppress the XPM deterioration of the signal light by, for example, having characteristics for lowering the gain of the wavelength portion of the pumping light source that causes the XPM deterioration and to maintain the signal quality of the signal light.

Furthermore, the forward Raman amplifier according to the embodiment changes the number of pumping light sources to be emitted, according to the zero-dispersion wavelength of the fiber. For example, in a case where the DSF and the dispersion shifted fiber are used for the optical transmission line, the number of pumping light sources is reduced by quenching the pumping light source with the wavelength that causes the XPM deterioration or the like. In addition, in a case of the DSF, it is not necessary to provide the pumping light source having the wavelength that causes the XPM deterioration in advance. As a result, it is possible to be compatible with the fiber type used for the optical transmission line, to suppress the XPM deterioration of the signal light, and to maintain the signal quality of the signal light.

Furthermore, the forward Raman amplifier according to the embodiment changes the power ratio between the plurality of pumping light sources having different wavelengths, according to the zero-dispersion wavelength of the fiber. The zero-dispersion wavelength of the SMF is different from the zero-dispersion wavelength of the DSF. In a case where the optical transmission line is the DSF, the XPM deterioration is caused in a part of the signal light according to the zero-dispersion wavelength. Therefore, the power ratio between the plurality of pumping light sources having different wavelengths is changed, according to the zero-dispersion wavelength of the fiber of the DSF. For example, it is possible to suppress the XPM deterioration of the signal light by lowering the power ratio of the pumping light source with the wavelength that causes the XPM deterioration or the like and to maintain the signal quality of the signal light.

Furthermore, the forward Raman amplifier according to the embodiment changes the wavelength characteristics of the gain, according to the zero-dispersion wavelength of the fiber. The zero-dispersion wavelength of the SMF is different from the zero-dispersion wavelength of the DSF. In a case where the optical transmission line is the DSF, the XPM deterioration is caused in a part of the signal light according to the zero-dispersion wavelength. Therefore, the inclination with respect to the wavelength of the gain is changed, according to the zero-dispersion wavelength of the fiber of the DSF. For example, it is possible to suppress the XPM deterioration of the signal light by lowering the gain of the wavelength that causes the XPM deterioration or the like and to maintain the signal quality of the signal light.

Furthermore, in a case where the signal light exists within the wavelength band obtained by folding the pumping light wavelength with respect to the zero-dispersion wavelength on the wavelength axis, the forward Raman amplifier according to the embodiment may turn off the power of the pumping light source with the wavelength. By quenching the pumping light with the wavelength overlapping the band of the signal light through this folding, it is possible to easily suppress the XPM deterioration of the signal light and to maintain the signal quality of the signal light.

Furthermore, in a case where the signal light exists within the wavelength band obtained by folding the pumping light wavelength with respect to the zero-dispersion wavelength on the wavelength axis, the forward Raman amplifier according to the embodiment may lower the pumping light power ratio of the wavelength to be lower than the pumping light power ratio of the wavelength in which the signal light does not exist within the wavelength band obtained by folding the pumping light wavelength with respect to the zero-dispersion wavelength. By lowering the pumping light power ratio of the wavelength overlapping the band of the signal light to be lower than the pumping light power ratio of the wavelength that does not overlap the signal light through this folding, it is possible to easily suppress the XPM deterioration of the signal light and to maintain the signal quality of the signal light.

Furthermore, the bidirectional Raman amplification system according to the embodiment may include the forward Raman amplifier described above and a backward Raman amplifier that generates gain wavelength characteristics in the opposite direction so as to compensate the gain wavelength characteristics generated by the forward Raman amplifier. As a result, while suppressing the XPM deterioration caused by the forward Raman pumping, it is possible to compensate the gain of the signal light decreased by the forward Raman with the backward Raman pumping and to maintain the signal quality.

Furthermore, the forward Raman amplifier according to the embodiment mounts the pumping light source with the wavelength that does not fall within the wavelength band obtained by folding the wavelength band of the signal light with respect to the zero-dispersion wavelength of the fiber on the wavelength axis. By mounting only the pumping light source with the wavelength that does not overlap the pumping light wavelength through this folding, it is possible to easily prevent the XPM deterioration. In this case, since the pumping light source is not provided, cost can be reduced.

Furthermore, in addition, in a case where there is the plurality of pumping light sources in which the signal light exists within the wavelength band obtained by folding the pumping light wavelength with respect to the zero-dispersion wavelength on the wavelength axis, the forward Raman amplifier according to the embodiment may reduce the power ratio as the pumping light source is closer to the zero-dispersion wavelength. As a result, it is possible to secure the Raman gain while suppressing the effect of the XPM.

Furthermore, in addition, in a case where the forward Raman amplifier according to the embodiment has a configuration using incoherent pumping light and coherent light as the pumping light, and in addition, in a case where the signal light exists within the wavelength band obtained by folding the pumping light wavelength with respect to the zero-dispersion wavelength on the wavelength axis for both of the coherent pumping light source and the incoherent pumping light source, the forward Raman amplifier may turn off the coherent pumping light source and reduce a power ratio of the incoherent pumping light source as the pumping light source is closer to the zero-dispersion wavelength. As a result, it is possible to secure the Raman gain while using the incoherent pumping light and the coherent light as the pumping light and suppressing the effect of the XPM.

Furthermore, regarding the forward Raman amplification system according to the embodiment, a bidirectional Raman amplification system that includes an upstream station that has the forward Raman amplifier, a downstream station that is coupled to the upstream station via an optical transmission line and includes the backward Raman amplifier, and the integrated control unit, the upstream station may transmit dummy light obtained by shaping the ASE light into a spectral shape of the signal light, and the downstream station may measure an OSNR of the dummy light and specify the zero-dispersion wavelength of the optical transmission line based on the measurement result. Although there is a possibility that the zero-dispersion wavelength of the fiber used for the optical transmission line varies for each manufacturing period, even with this variation, it is possible to easily measure the zero-dispersion wavelength for each type of the optical transmission line and to perform Raman amplification suitable for the type.

Furthermore, in the embodiment, the control unit may be arranged in any one of the plurality of optical transmission devices. Although the control unit may be arranged outside the optical transmission device, cost can be reduced by arranging the control unit in any one of the plurality of optical transmission devices.

For example, a forward Raman amplification system may be provided which includes: an upstream station configured to include a forward Raman amplifier that includes pumping light sources with a plurality of pumping wavelengths, an amplified spontaneous emission (ASE) light source, and a device that shapes the ASE light source; a downstream station that is coupled to the upstream station via an optical transmission line and includes a device that measures an optical signal to noise ratio (OSNR); and an integrated control unit. The upstream station transmits dummy light with a plurality of wavelengths obtained by shaping ASE light into a spectral shape of signal light, the downstream station measures first OSNR wavelength characteristics of the dummy light in a state where all pumping light of the forward Raman amplifier is quenched, and further measures second OSNR wavelength characteristics of the dummy light in a state where only a pumping light source with a first pumping wavelength, among the plurality of pumping wavelengths in the forward Raman amplifier, is lighted, and determines power of the pumping light source with the first pumping wavelength or a pumping light power ratio, based on the first OSNR wavelength characteristics and the second OSNR wavelength characteristics.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A forward Raman amplifier comprising:
a plurality of pumping light sources with different wavelengths,
wherein the forward Raman amplifier, according to a fiber type or a zero-dispersion wavelength of the fiber, changes the number of pumping light sources to be emitted, changes a power ratio between the plurality of pumping light sources with the different wavelengths, or changes wavelength characteristics of a gain, according to a fiber type.

2. The forward Raman amplifier according to claim 1, wherein in a case where signal light exists within a wavelength band obtained by folding a pumping light wavelength with respect to a zero-dispersion wavelength on a wavelength axis, power of a pumping light source with the wavelength is turned off.

3. The forward Raman amplifier according to claim 1, wherein a pumping light source is mounted that has a wavelength that does not fall within a wavelength band obtained by folding a wavelength of signal light with respect to a zero-dispersion wavelength of a fiber on a wavelength axis.

4. A forward Raman amplifier,
wherein in a case where signal light exists within a wavelength band obtained by folding a pumping light wavelength with respect to a zero-dispersion wavelength on a wavelength axis, a pumping light power ratio of the wavelength is lowered to be lower than a pumping light power ratio of a wavelength in which signal light does not exist within the wavelength band obtained by folding the pumping light wavelength with respect to the zero-dispersion wavelength.

5. The forward Raman amplifier according to claim 4, wherein in a case where signal light exists within a wavelength band obtained by folding a pumping light wavelength with respect to a zero-dispersion wavelength on a wavelength axis, power of a pumping light source with the wavelength is turned off.

6. The forward Raman amplifier according to claim 4, wherein a pumping light source is mounted that has a wavelength that does not fall within a wavelength band obtained by folding a wavelength of signal light with respect to a zero-dispersion wavelength of a fiber on a wavelength axis.

7. The forward Raman amplifier according to claim 4, wherein in addition, in a case where a plurality of the pumping light sources exists in which the signal light exists within the wavelength band obtained by folding the pumping light wavelength with respect to the zero-dispersion wavelength on the wavelength axis, a pumping light source closest to the zero-dispersion wavelength is quenched.

8. The forward Raman amplifier according to claim 4, wherein in addition, incoherent pumping light and coherent light are used as the pumping light, and
in addition, in a case where the signal light exists within the wavelength band obtained by folding the pumping light wavelength with respect to the zero-dispersion wavelength on the wavelength axis, for both of a coherent pumping light source and incoherent pumping light source, the coherent pumping light source is quenched, and a pumping light source closest to the zero-dispersion wavelength among the incoherent pumping light source is quenched.

9. A bidirectional Raman amplification system comprising:
a forward Raman amplifier including a plurality of pumping light sources with different wavelengths and configured to, according to a fiber type or a zero-dispersion wavelength of the fiber, change the number of pumping light sources to be emitted, change a power ratio between the plurality of pumping light sources with the different wavelengths, or change wavelength characteristics of a gain, according to a fiber type; and
a backward Raman amplifier configured to generate wavelength characteristics of a gain in an opposite direction so as to compensate wavelength characteristics of a gain generated by the forward Raman amplifier.
